(19) United States
(12) Patent Application Publication
(10) Pub. No.: US 2026/0286163 A1
(43) Pub. Date: Sep. 24, 2026

(54) METHODS FOR PRODUCING CARBON NANOTUBE DISPERSION PASTE, MIXTURE PASTE, AND ELECTRODE LAYER FOR LITHIUM ION SECONDARY BATTERY

(71) Applicant: KANSAI PAINT CO., LTD., Amagasaki-shi, Hyogo (JP)

(72) Inventors: Ryoga MIYAMURA, Hiratsuka-shi, Kanagawa (JP); Masaya SHIBATA, Hiratsuka-shi, Kanagawa (JP)

(21) Appl. No.: 19/167,931

(22) PCT Filed: Mar. 26, 2024
(86) PCT No.: PCT/JP2024/011901

§ 371 Date: Sep. 23, 2025

(30) Foreign Application Priority Data
Mar. 27, 2023 (JP) 2023-049203

(51) Int. Cl. C09D 127/16; C09D 7/40; H01M 4/04; H01M 4/139; H01M 4/62; H01M 10/0525

(52) U.S. Cl. CPC C09D 127/16; C09D 7/70; H01M 4/0404; H01M 4/139; H01M 4/625; H01M 10/0525

(57) ABSTRACT

An object is to provide methods for producing a carbon nanotube dispersion paste and a mixture paste that are excellent in pigment dispersibility and storage stability even at a high pigment concentration, and another object is to provide an electrode layer for a lithium ion secondary battery excellent in various properties (e.g., conductivity and battery performance). Provided as a solution is a method for producing a carbon nanotube dispersion paste, the method including a step of mixing and dispersing components including a dispersing resin (A) having a heterocyclic ring and/or an alkyl group having 12 or more carbon atoms, a carbon nanotube (B), a solvent (C) having a water content of less than 10000 ppm, and polyvinylidene fluoride (D) that can be optionally included, wherein the carbon nanotube dispersion paste has a water content of less than 10000 ppm.

### TECHNICAL FIELD

The present invention relates to methods for producing a carbon nanotube dispersion paste (also referred to herein as a conductive pigment paste) excellent in conductivity, pigment dispersibility, and storage stability even at a high pigment concentration, a mixture paste, and an electrode layer for a lithium ion secondary battery, and a method for producing a battery electrode layer having high battery performance.

### BACKGROUND ART

In the related art, pasty pigment dispersions obtained by dispersing a pigment in a mixture of a pigment dispersing resin, a solvent, and the like have been widely used in the fields of paints, battery electrodes, coating materials, electromagnetic shields, display panels, touch-screen panels, colored films, colored sheets, decorative materials, protective materials, magnet-modifying materials, printing inks, device members, electronic equipment members, printed wiring boards, solar cells, functional rubber members, molded resin films, and the like. Furthermore, to provide these materials with properties such as electrostatic application properties, conductivity, electromagnetic shielding properties, and antistatic properties, conductive pigments, conductive polymers, and the like have been incorporated.

In these fields, improvements in properties such as pigment dispersibility, storage stability, conductivity, coatability, and finish quality have been increasingly demanded. Accordingly, pigment dispersing resins and pigment pastes having high pigment dispersion capability and high pigment dispersion stability sufficient to prevent reaggregation of pigment particles in formed pigment dispersions have been under development.

In designing a pigment paste, for a pigment dispersing resin not to adversely affect the conductive performance, etc. of an end product itself, such as a coating film, or from the viewpoint of reducing the amount of solvent and pigment dispersing resin used and reducing the amount of energy used in drying, it is important to produce a pigment paste in which a pigment is densely and uniformly dispersed with a small amount of pigment dispersing resin.

For example, PTL 1 discloses a method for producing a slurry for a lithium secondary battery electrode, the method including dispersing a solvent containing fibrous carbon with a media (hereinafter also referred to as “media”) type disperser to obtain a slurry and kneading the slurry with an electrode active material, thereby obtaining a slurry to be applied to a current collector. However, in the case of a paste having a high pigment concentration and/or a high viscosity, there have been cases where uniform dispersion cannot be achieved and storage stability is poor. In particular, when the slurry contains a large amount of water, an increase in viscosity or gelation has sometimes occurred.

### CITATION LIST

### Patent Literature

PTL 1: Japanese Unexamined Patent Application Publication No. 2014-182892

### SUMMARY OF INVENTION

### Technical Problem

An object of the present invention is to provide a method for producing a carbon nanotube dispersion paste that is excellent in pigment dispersibility and storage stability even when it is a paste having a high pigment concentration and/or a high viscosity and a method for producing a mixture paste, and another object is to provide an electrode layer for a lithium ion secondary battery, the electrode layer being excellent in finish quality, conductivity, etc.

### Solution to Problem

As a result of intensive studies to solve the above problems, the present inventors have found that the above problems can be solved by a method for producing a carbon nanotube dispersion paste, the method including a step of mixing and dispersing components including a dispersing resin (A) having a heterocyclic ring and/or an alkyl group having 12 or more carbon atoms, a carbon nanotube (B), a solvent (C) having a water content of less than 10000 ppm, and polyvinylidene fluoride (D) that can be optionally included, wherein the carbon nanotube dispersion paste has a water content of less than 10000 ppm, thereby completing the present invention.

Thus, the present invention provides methods for producing a carbon nanotube dispersion paste, a mixture paste, and an electrode layer for a lithium ion secondary battery described below.

### Item 1.

A method for producing a carbon nanotube dispersion paste, the method including a step of mixing and dispersing components including a dispersing resin (A) having a heterocyclic ring and/or an alkyl group having 12 or more carbon atoms, a carbon nanotube (B), a solvent (C) having a water content of less than 10000 ppm, and polyvinylidene fluoride (D) that can be optionally included, wherein the carbon nanotube dispersion paste has a water content of less than 10000 ppm.

### Item 2.

The method for producing a carbon nanotube dispersion paste according to Item 1, wherein the mixing and/or the dispersing is carried out in an atmosphere at a dew point of 10° C. or lower.

### Item 3.

The method for producing a carbon nanotube dispersion paste according to Item 1 or 2, wherein the dispersing resin (A) having a heterocyclic ring and/or an alkyl group having 12 or more carbon atoms has at least one polar functional group selected from the group consisting of an amide group, an imide group, a hydroxyl group, a carboxyl group, a sulfonic acid group, a phosphoric acid group, an amino group, and a cyano group, and has a polar functional group concentration of 0.1 mmol/g to 8.5 mmol/g.

### Item 4.

The method for producing a carbon nanotube dispersion paste according to any one of Items 1 to 3, wherein the solvent (C) includes a regenerated product of N-methyl-2-pyrrolidone, and a water content in N-methyl-2-pyrrolidone is controlled at less than 10000 ppm.

### Item 5.

The method for producing a carbon nanotube dispersion paste according to any one of Items 1 to 4, wherein the carbon nanotube dispersion paste contains the polyvinylidene fluoride (D).

### Item 6.

The method for producing a carbon nanotube dispersion paste according to Item 5, wherein a step of mixing the polyvinylidene fluoride (D) includes a step of mixing and dissolving the polyvinylidene fluoride (D) in advance with a solvent having a liquid temperature of 40° C. or higher or includes a step of mixing the polyvinylidene fluoride (D) with a solvent and then performing heating to a temperature of 40° C. or higher.

### Item 7.

The method for producing a carbon nanotube dispersion paste according to any one of Items 1 to 6, wherein the carbon nanotube dispersion paste further contains a highly polar low-molecular-weight component (E).

### Item 8.

The method for producing a carbon nanotube dispersion paste according to any one of Items 1 to 7, wherein the carbon nanotube dispersion paste further contains a dehydrating agent (F).

### Item 9.

The method for producing a carbon nanotube dispersion paste according to any one of Items 1 to 8, wherein the carbon nanotube (B) is dry-dispersed in advance with a media-type pulverizer.

### Item 10.

The method for producing a carbon nanotube dispersion paste according to any one of Items 1 to 9, wherein the step of mixing and dispersing includes a step of sequentially performing
Step 1: a step of adding the components into a disperser, the components including the carbon nanotube (B) in an amount of 70 mass % or less based on 100 mass % of a total amount of the carbon nanotube (B) contained in the carbon nanotube dispersion paste obtained after dispersion, and performing dispersion treatment, and
Step 2: a step of adding the carbon nanotube (B) into the disperser until a desired concentration is reached, and performing dispersion treatment.

### Item 11.

The method for producing a carbon nanotube dispersion paste according to any one of Items 1 to 10, wherein when an amount of moisture adsorption on the carbon nanotube (B) is Y (mass %), and a BET specific surface area of the carbon nanotube (B) is Z (m²/g), a value of X obtained by a formula below;

$$X = Y \times Z$$

is in a range of X≤500, and
when the amount of moisture adsorption Y is measured under conditions where a mass of the carbon nanotube dried at a temperature of 140° C. for 3 hours is Y1, and a mass of the carbon nanotube further left to stand at a temperature of 20° C. and a relative humidity of 65% for 24 hours is Y2, a value (mass %) of Y obtained by a formula below

Amount of moisture adsorption Y=(Y2−Y1)/Y1×100

is the amount of moisture adsorption Y.

### Item 12.

A method for producing a mixture paste for a lithium ion secondary battery, the method including a step of mixing a carbon nanotube dispersion paste obtained by the method for producing a carbon nanotube dispersion paste according to Items 1 to 11 with an electrode active material (G). Item 13.

A method for producing a mixture paste for a lithium ion secondary battery, the method including steps below;
a step of producing a carbon nanotube dispersion paste, the step including a step of mixing and dispersing components including a dispersing resin (A) having a heterocyclic ring and/or an alkyl group having 12 or more carbon atoms, a carbon nanotube (B), a solvent (C) having a water content of less than 10000 ppm, and polyvinylidene fluoride (D) that can be optionally included, wherein the carbon nanotube dispersion paste has a water content of less than 10000 ppm, and
   a step of producing a mixture paste for a lithium ion secondary battery, the step including a step of mixing the carbon nanotube dispersion paste with an electrode active material (G), wherein the mixture paste has a water content of less than 10000 ppm, and the electrode active material (G) is an electrode active material composite (G-1) obtained by covering at least a part of a surface of the electrode active material (G) with a carbon nanotube.

### Item 14.

A method for producing an electrode layer for a lithium ion secondary battery, the method including a step of applying a mixture paste obtained by the production method according to Item 12 to a current collector.

### Item 15.

A method for producing an electrode for a lithium ion secondary battery, the method including a step of applying an electrode insulating portion to an end portion or an upper layer of an electrode layer obtained by the production method according to Item 14.

### Item 16.

A method for producing a lithium ion secondary battery, the method using a positive electrode including an electrode layer obtained by the production method according to Item 14, a negative electrode, a nonaqueous electrolyte, and a separator.

### Advantageous Effects of Invention

The method for producing a carbon nanotube dispersion paste according to the present invention is excellent in pigment dispersibility and storage stability even at a high pigment concentration and/or a high viscosity and can sufficiently reduce the viscosity of a paste with a relatively small amount of dispersing resin. An electrode layer thereof for a lithium ion secondary battery is excellent in finish quality, conductivity, battery performance, etc.

### DESCRIPTION OF EMBODIMENTS

Hereinafter, embodiments of the present invention will be described in detail.

It should be appreciated that the present invention is not limited to the following embodiments and includes various modifications practiced without departing from the gist of the present invention.

In the present invention, a paste containing a carbon nanotube is referred to as a “carbon nanotube dispersion paste”, and can also be referred to as a “conductive pigment paste”.

A paste prepared by further blending at least one electrode active material and various other optional components in order to apply the carbon nanotube dispersion paste is referred to as a “mixture paste”. A product obtained by application of the mixture paste to a coating target and drying is referred to as a “coating film” or a “mixture layer”.

It can be said that the carbon nanotube dispersion paste is a paste containing substantially no electrode active materials.

The carbon nanotube can also be abbreviated as the “CNT”.

When the coating film is used in a battery electrode, it can also be referred to as an “electrode layer”.

In the present invention, since the water content of the carbon nanotube dispersion paste is less than 10000 ppm [furthermore, the water content of a solvent (C) is less than 10000 ppm], an increase in viscosity and gelation during storage can be suppressed.

Although the mechanism by which the carbon nanotube dispersion paste and the mixture paste (for a lithium ion secondary battery) experience an increase in viscosity and gelation has not been elucidated, the following mechanism is presumed.

For example, in a mixture paste containing polyvinylidene fluoride, the acidity of a proton adjacent to a fluoro group in polyvinylidene fluoride is very high due to the electron withdrawing property of the fluoro group, and thus the dissociation of the proton readily proceeds particularly under basic conditions. It is presumed that such proton dissociation tends to proceed particularly when water is present in the carbon nanotube dispersion paste and the mixture paste. An anion is formed on the carbon after the proton dissociation, and the anion promotes elimination of the fluoro group, thus resulting in the formation of a double bond in the main chain of the polyvinylidene fluoride molecule. Then, a plurality of polyvinylidene fluoride molecules that have come to have a double bond are polymerized to form a higher molecular weight structure, thus presumably leading to an increase in viscosity and gelation. In particular, the electrode active material in the mixture paste may contain lithium hydroxide which is a relatively strong base, and thus the increase in viscosity and gelation are noticeable in the mixture paste.

It is considered that in the present invention, by using a raw material whose water content is predetermined and predetermining the water contents of the carbon nanotube dispersion paste and the mixture paste, the polymerization of a polymer component (polyvinylidene fluoride) is suppressed, and the increase in viscosity and gelation of the carbon nanotube dispersion paste or the mixture paste (for a lithium ion secondary battery) are suppressed.

It is practically impossible to reduce the water content to zero because there are introduction from various raw materials (particularly, solvents), entry from water vapor contained in the air during the production process, etc. Therefore, the water content of the carbon nanotube dispersion paste that can be used in the present invention is preferably 100 ppm or more, more preferably 200 ppm or more, still more preferably 500 ppm or more. The water content of the solvent (C) is preferably 100 ppm or more, more preferably 200 ppm or more, still more preferably 500 ppm or more.
In the case of the above lower limit, the production can be carried out without excessive water content control (water content reduction) of raw materials or excessive water content control (water entry reduction) during the production process.

In the paste production of the present invention, the mixing and/or pigment dispersion is preferably carried out in an atmosphere at a dew point of 10° C. or lower, more preferably a dew point of 7° C. or lower, still more preferably a dew point of 5° C. or lower, from the viewpoint of water entry reduction and storage stability.

### [Method for Producing Carbon Nanotube Dispersion Paste]

The present invention is a method for producing a carbon nanotube dispersion paste, the method including a step of mixing and dispersing components including a dispersing resin (A) having a heterocyclic ring and/or an alkyl group having 12 or more carbon atoms, a carbon nanotube (B), a solvent (C) having a water content of less than 10000 ppm, and polyvinylidene fluoride (D) that can be optionally included, wherein the carbon nanotube dispersion paste has a water content of less than 10000 ppm.

The water content of the carbon nanotube dispersion paste is preferably less than 7500 ppm, more preferably less than 5000 ppm, still more preferably less than 2500 ppm, particularly preferably less than 1000 ppm.
The carbon nanotube dispersion paste in the present invention can be said to be a substantially nonaqueous paste.

In the present invention, the water content can be measured by Karl Fischer coulometric titration. Specifically, it can be measured using a Karl Fischer moisture titrator (manufactured by Kyoto Electronics Manufacturing Co., Ltd., trade name “MKC-610”) with an evaporator (manufactured by Kyoto Electronics Manufacturing Co., Ltd., trade name “ADP-611”) installed in the apparatus being set at a temperature of 130° C.

Dispersing Resin (A) Having Heterocyclic Ring and/or Alkyl Group Having 12 or More Carbon Atoms

As the dispersing resin (A) having a heterocyclic ring and/or an alkyl group having 12 or more carbon atoms, any resin having a heterocyclic ring and/or an alkyl group having 12 or more carbon atoms in the resin can be suitably used.

The heterocyclic ring is a ring that includes carbon atoms and also other atoms in its cyclic structure, and examples of other atoms include oxygen, nitrogen, and sulfur. The number of cyclic structures included in the heterocyclic ring is preferably one or two, more preferably one. The other atom other than carbon constituting the ring is preferably oxygen and/or nitrogen, more preferably oxygen. It is considered that when an atom other than carbon atoms is included as an atom constituting the ring, polarization occurs in the heterocyclic ring, which can strongly act on a carbonaceous conductive pigment (the carbon nanotube in the present invention). It is also considered that when a dispersing resin has a relatively bulky side chain such as a heterocyclic ring or an alkyl group having 12 or more carbon atoms, steric repulsion improves pigment dispersibility and storage stability.

The method of introducing the heterocyclic ring into the dispersing resin (A) is not particularly limited, and is, for example, a (co)polymerization reaction of a monomer including the heterocyclic ring, a modification reaction of a polymer (resin), and/or an addition reaction. Examples of polymerizable monomers including the heterocyclic ring include 2- or 4-vinylpyridine, N-vinylimidazole, N-vinylpyrrole, N-vinyl-2-pyrrolidone, N-vinyl-ε-caprolactam, N-vinyl-2-piperidone, N-vinyl-3-morpholinone, N-vinyl-1,3-oxazin-2-one, N-vinyl-3,5-morpholinedione, glycidyl (meth)acrylate, maleic anhydride, and itaconic anhydride. These can be used alone or in combination of two or more.

The alkyl group having 12 or more carbon atoms may be any alkyl group (hydrocarbon group) known per se, and is preferably a linear or branched alkyl group, more preferably a linear alkyl group.

The alkyl group having 12 or more carbon atoms is preferably an alkyl group having 12 or more and less than 30 carbon atoms, more preferably an alkyl group having 15 or more and less than 26 carbon atoms, still more preferably an alkyl group having 19 or more and less than 24 carbon atoms.

The method of introducing the alkyl group having 12 or more carbon atoms into the dispersing resin (A) is not particularly limited, and is, for example, a (co)polymerization reaction of a monomer including the alkyl group having 12 or more carbon atoms, a modification reaction of a polymer (resin), and/or an addition reaction. Examples of polymerizable monomers including the alkyl group having 12 or more carbon atoms include lauryl (meth)acrylate, stearyl (meth)acrylate, isostearyl (meth)acrylate, behenyl (meth)acrylate, lauryl (meth)acrylamide, stearyl (meth)acrylamide, and behenyl (meth)acrylamide. These can be used alone or in combination of two or more.

The resin serving as a base may be of any type as long as it is a resin other than the polyvinylidene fluoride (D) described later. Examples include acrylic resins, polyester resins, epoxy resins, polyether resins, alkyd resins, urethane resins, polyvinyl alcohol, polyvinyl acetal, polyvinylpyrrolidone, polyvinyl acetate, silicone resins, polycarbonate resins, chlorine-based resins, and composite resins thereof. These resins may contain a heterocyclic ring and/or an alkyl group having 12 or more carbon atoms, or after these resins are synthesized, a heterocyclic ring and/or an alkyl group having 12 or more carbon atoms may be introduced through addition or modification to thereby produce a resin having a heterocyclic ring and/or an alkyl group having 12 or more carbon atoms. These resins can be used alone or in combination of two or more.

In particular, from the viewpoint of, for example, pigment dispersibility, storage stability, and finish quality, the dispersing resin (A) preferably contains a vinyl (co)polymer (A1) obtained by polymerizing or copolymerizing a monomer including a polymerizable unsaturated group-containing monomer represented by the following formula (1), and is particularly preferably an acrylic resin obtained by (co)polymerizing a polymerizable unsaturated group-containing monomer containing at least one (meth)acryloyl group.

The term “(co)polymer” in the present invention is meant to include both a polymer obtained by polymerizing one kind of a monomer and a copolymer obtained by copolymerizing two or more kinds of monomers.

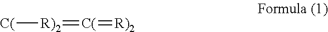

[In the above formula, R's may be the same or different from each other and are each a hydrogen atom or an organic group. R's may be linked to each other to form a ring.]

The vinyl (co)polymer (A1) can be produced by a polymerization method known per se. For example, it is preferable, but not necessary, to use solution polymerization, and bulk polymerization, emulsion polymerization, suspension polymerization, or the like may also be used. When solution polymerization is performed, continuous polymerization or batch polymerization may be used, and a monomer may be charged in one portion or multiple portions or may be added continuously or intermittently.

The polymerization initiator used in the solution polymerization is not particularly limited, and specifically, for example, a known radical polymerization initiator such as an azo compound such as azobisisobutyronitrile, 2,2′-azobis(2-methylbutyronitrile), azobis-2,4-dimethylpaleronitrile, or azobis(4-methoxy-2,4-dimethylvaleronitrile); a peroxide such as acetyl peroxide, benzoyl peroxide, lauroyl peroxide, acetylcyclohexylsulfonyl peroxide, or 2,4,4-trimethylpentyl-2-peroxyphenoxyacetate; a percarbonate compound such as diisopropyl peroxydicarbonate, di-2-ethylhexyl peroxydicarbonate, or diethoxyethyl peroxydicarbonate; a perester compound such as t-butyl peroxyneodecanoate, α-cumyl peroxyneodecanoate, or t-butyl peroxyneodecanoate; azobisdimethylvaleronitrile, or azobismethoxyvaleronitrile can be used.

The polymerization reaction temperature is not particularly limited, and can be set typically in the range of about 30° C. or higher and 200° C. or lower.

The degree of polymerization of the vinyl (co)polymer (A1) obtainable as described above is, for example, 100 or more, preferably 150 or more, and is, for example, 4,000 or less, preferably 3,000 or less, more preferably 700 or less.

The weight-average molecular weight is, for example, 1,000 or more, preferably 2,000 or more, more preferably 7,000 or more, and is, for example, 2,000, 000 or less, preferably 1,000, 000 or less, more preferably 500,000 or less.

Unless otherwise specified, a weight-average molecular weight in this specification is a value obtained by converting a retention time (retention volume) measured using a gel permeation chromatograph (GPC) into a molecular weight of polystyrene by using a retention time (retention volume) of standard polystyrene of known molecular weight measured under the same conditions. Specifically, the weight-average molecular weight can be measured using “HLC8120GPC” (manufactured by Tosoh Corporation, trade name) as a gel permeation chromatograph and four columns: “TSKgel G-4000HXL”, “TSKgel G-3000HXL”, “TSKgel G-2500HXL”, and “TSKgel G-2000HXL” (all manufactured by Tosoh Corporation, trade names), under the following conditions: mobile phase, tetrahydrofuran; measurement temperature, 40° C.; flow rate, 1 mL/min; and detector, RI.

After completion of synthesis, the vinyl (co)polymer (A1) can be subjected to desolvation and/or solvent replacement to be converted into a solid or a resin solution in any replaced solvent.

The desolvation may be performed by heating under normal pressure or may be performed under reduced pressure. In the solvent replacement, a replacement solvent may be supplied at any stage, i.e., before, during, or after the desolvation.

The content of the heterocyclic ring in the dispersing resin (A), in the case of the vinyl (co)polymer (A1), is preferably 1 to 100 mass %, more preferably 10 to 100 mass %, still more preferably 30 to 99 mass %, particularly preferably 50 to 95 mass %, in terms of the mass percentage of the polymerizable monomer including the heterocyclic ring relative to 100 mass % of all the monomers.

The content of the alkyl group having 12 or more carbon atoms in the dispersing resin (A), in the case of the vinyl (co)polymer (A1), is preferably 1 to 100 mass %, more preferably 10 to 90 mass %, still more preferably 20 to 80 mass %, particularly preferably 30 to 60 mass %, in terms of the mass percentage of the polymerizable monomer including the alkyl group having 12 or more carbon atoms relative to 100 mass % of all the monomers.
When the reactive compound (the compound having a heterocyclic ring or an alkyl group having 12 or more carbon atoms) is added to the resin later, the content of the heterocyclic ring and the alkyl group having 12 or more carbon atoms is calculated as the mass percentage of this compound.

The dispersing resin (A) having a heterocyclic ring and/or an alkyl group having 12 or more carbon atoms preferably has, in addition to the heterocyclic ring and/or the alkyl group having 12 or more carbon atoms, at least one polar functional group selected from the group consisting of an amide group, an imide group, a hydroxyl group, a carboxyl group, a sulfonic acid group, a phosphoric acid group, an amino group, and a cyano group, and has a polar functional group concentration of preferably 0.1 mmol/g to 8.5 mmol/g, more preferably 0.2 mmol/g to 6.0 mmol/g, still more preferably 0.3 mmol/g to 4.0 mmol/g, particularly preferably 0.4 mmol/g to 2.0 mmol/g. The above acid groups and amino group may be in salt form.

In particular, as the polar functional group, the dispersing resin (A) preferably has a hydroxyl group, an acid group, and/or an amino group, more preferably has a hydroxyl group and/or an amino group, and still more preferably has an amino group.
The amino group is typically a secondary or tertiary amino group, preferably a tertiary amino group.

When the dispersing resin (A) having a heterocyclic ring and/or an alkyl group having 12 or more carbon atoms is converted from a solid state into a resin solution, from the viewpoint of solvent solubility, it is preferably mixed and dissolved in advance with a solvent having a liquid temperature of 60° C. or higher (preferably 80° C. or higher) (the upper limit is 200° C. or lower, preferably 100° C. or lower) to be converted into a resin solution, and is preferably mixed with other components (e.g., the components (B), (C), and (D)] after the conversion into the resin solution.

The “liquid temperature” is the temperature of the solvent or the resin solution at the time of dissolution.
The dispersing resin (A) in a solid state may be mixed and dissolved in a solvent at 60° C. or higher in advance, or the dispersing resin (A) in a solid state may be mixed with a solvent and then heated to a temperature of 60° C. or higher. Components other than the dispersing resin (A) and the solvent may be contained.
The solvent for use may be a single solvent or a combination of two or more solvents, and those listed in Solvent (C) given later can be suitably used.
The resin solution obtained through thermal dissolution as described above is preferably cooled to a predetermined temperature of 10° C. to 40° C., and this cooling step is preferably carried out such that the cooling rate defined by the following formula:

Cooling rate=(solution temperature at the start of cooling−solution temperature at the end of cooling)/cooling time

is 0.5° C./min or more (preferably 1° C./min or more) from the viewpoint of preventing precipitation.

The solid content of the dispersing resin (A) having a heterocyclic ring and/or an alkyl group having 12 or more carbon atoms is, for example, 0.1 mass % or more, preferably 1 mass % or more, more preferably 3 mass % or more, and is, for example, 40 mass % or less, preferably 30 mass % or less, more preferably 20 mass % or less, based on 100 mass % of the total solid content of the carbon nanotube dispersion paste. The solid content of the dispersing resin (A) having a heterocyclic ring and/or an alkyl group having 12 or more carbon atoms is, for example, 0.1 mass % or more, preferably 0.4 mass % or more, more preferably 0.7 mass % or more, and is, for example, 10 mass % or less, preferably 5 mass % or less, more preferably 2 mass % or less, based on 100 mass % of the total amount of the carbon nanotube dispersion paste.

The solid content of the dispersing resin (A) having a heterocyclic ring and/or an alkyl group having 12 or more carbon atoms is, for example, 0.1 mass % or more, preferably 1 mass % or more, more preferably 5 mass % or more, and is, for example, 150 mass % or less, preferably 120 mass % or less, more preferably 80 mass % or less, based on 100 mass % of the content of the carbon nanotube (B).

### Carbon Nanotube (B)

The carbon nanotube (B) may be either a single-walled carbon nanotube or a multi-walled carbon nanotube, or a combination thereof. Particularly in terms of viscosity, conductivity, and cost, it is preferable to use a multi-walled carbon nanotube.

The content of the carbon nanotube (B) is, for example, 0.5 mass % or more, preferably 1 mass % or more, more preferably 2 mass % or more, and is, for example, 10 mass % or less, preferably 7 mass % or less, more preferably 6 mass % or less, based on 100 mass % of the total amount of the carbon nanotube dispersion paste.

The content of the carbon nanotube (B) is, for example, 5 mass % or more, preferably 10 mass % or more, more preferably 20 mass % or more, and is, for example, 90 mass % or less, preferably 70 mass % or less, more preferably 50 mass % or less, based on 100 mass % of the total solid content of the carbon nanotube dispersion paste.

The average outer diameter of the carbon nanotube (B) is, for example, 1 nm or more, preferably 3 nm or more, more preferably 5 nm or more, and is, for example, 30 nm or less, preferably 28 nm or less, more preferably 25 nm or less.

The average length of the carbon nanotube (B) is, for example, 0.1 μm or more, preferably 1 μm or more, more preferably 5 μm or more, and is, for example, 100 μm or less, preferably 80 μm or less, more preferably 60 μm or less.

The BET specific surface area of the carbon nanotube (B) is typically 100 m²/g or more, preferably 130 m²/g or more, more preferably 160 m²/g or more, and is typically 800 m²/g or less, preferably 600 m²/g or less, more preferably 400 m²/g or less, in terms of viscosity and conductivity.

The BET specific surface area in the present invention can be determined by a BET method using nitrogen adsorption measurement. Specifically, for example, the BET specific surface area (m²/g) can be measured in accordance with JIS Z 8830:2013 using a specific surface area meter (BERSORP-MAX (MicrotracBEL Corp.)).

The acidic group content of the carbon nanotube (B) is typically 0.01 mmol/g or more, preferably 0.01 mmol/g or more, and is typically 1.0 mmol/g or less, preferably 0.5 mmol/g or less, more preferably 0.2 mmol/g or less, still more preferably 0.1 mmol/g or less, from the viewpoint of dispersibility and storability. An acidic group content of 0.01 mmol/g or more leads to good dispersibility, and an acidic group content of 1.0 mmol/g or less leads to good storability.

The acidic group can be introduced by the following acid treatment of the carbon nanotube.

### (Acid Treatment Method)

The method of the acid treatment is not particularly limited as long as an acid can be brought into contact with the carbon nanotube, and immersion of the carbon nanotube in an acid treatment liquid (aqueous acid solution) is preferred. Examples of the acid contained in the acid treatment liquid include, but are not limited to, nitric acid, sulfuric acid, and hydrochloric acid. These can be used alone or in combination of two or more. Of these, nitric acid and sulfuric acid are preferred.

The acidic group content of the carbon nanotube can be adjusted by, for example, the concentration, temperature, and treatment time of the acid treatment liquid.

After the acid treatment, an excess acid component adhering to the surface is removed by a washing method described below, whereby an acid-treated carbon nanotube can be obtained.

The method of washing the carbon nanotube subjected to the acid treatment is not particularly limited, and washing with water is preferred. For example, the carbon nanotube is recovered by a known method, such as filtration, from the carbon nanotube subjected to the acid treatment, and then the carbon nanotube is washed with water. After the washing, the water attached to the surface is, for example, removed by drying as required, whereby the acid-treated carbon nanotube can be obtained.

The median diameter (D50) of the carbon nanotube (B) on a volume basis, when measured by a method described in EXAMPLES given later, is typically 10 μm or more, preferably 15 μm or more, more preferably 20 μm or more, and is typically 250 μm or less, preferably 200 μm or less, more preferably 150 μm or less. Here, the median diameter (D50) can be determined by irradiating particles of the carbon nanotube with laser light and converting the diameter of the carbon nanotube into a spherical shape based on the scattered light. Larger median diameters (D50) mean that more carbon nanotube aggregates are present and dispersibility is poorer. When the median diameter (D50) is larger than 250 μm, carbon nanotube aggregates are highly likely to be present in an electrode, leading to non-uniform conductivity across the electrode. When the median diameter (D50) is smaller than 10 μm, the conductive path is insufficient due to the short fiber length, leading to low conductivity. When the median diameter (D50) is in the range of 10 μm or more and 250 μm or less, the carbon nanotube can be uniformly dispersed in the electrode while maintaining conductivity.

In a Raman spectrum of the carbon nanotube (B), a G/D ratio, where G is a maximum peak intensity in the range of 1560 cm⁻¹ or more and 1600 cm⁻¹ or less, and D is a maximum peak intensity in the range of 1310 cm⁻¹ or more and 1350 cm⁻¹ or less, is typically 0.1 or more, preferably 0.4 or more, more preferably 0.6 or more, and is typically 5.0 or less, preferably 3.0 or less, more preferably 1.0 or less.

Here, when the G/D ratio is in the range of 0.1 or more and 5.0 or less, the numbers of carbon surface defects and crystal grain boundaries are small, and conductivity tends to be high, which is preferred.

### (Dry Dispersion of Carbon Nanotube)

Before the carbon nanotube dispersion paste is produced, the carbon nanotube (B) can be dry-dispersed in advance with a media-type pulverizer.

The “dry dispersion” in the present invention means pulverization (including disintegration) with a pulverizer at a solid concentration in a pulverized component of 80 mass % or more (preferably 90 mass % or more, more preferably 95 mass % or more, still more preferably 98 mass % or more). Although components other than the carbon nanotube (B) can be pulverized together, it is preferable that the carbon nanotube (B) content included in the solid content in the pulverized component is typically 80 mass % or more, preferably 90 mass % or more, more preferably 95 mass % or more, still more preferably 98 mass % or more, particularly preferably the carbon nanotube (B) alone.
As the components other than the carbon nanotube (B) in the pulverized component, solvents, resins, pigments other than the carbon nanotube (B), and others can be suitably used, but it is preferable to contain substantially only the carbon nanotube (B).
The “solid concentration” is the percentage (mass %) of a solid obtained when 1 g of a sample is dried by heating at 130° C. for 3 hours.

The dry dispersion refers to pulverizing a pigment substantially without containing a liquid component, and enables highly efficient and powerful pulverization (disintegration) because energy can be directly applied to the pigment. In addition, since the pulverized surface is activated and interacts with surrounding substances, good dispersibility and storage stability are provided in the step of dispersing the paste described later, and a coating film thereof can be provided with high conductivity and high finish quality.

In the dry dispersion, pulverization is carried out using a pulverizer containing pulverization media such as glass beads, zirconia beads, or steel balls. The pulverization is carried out utilizing a pulverization force or a destruction force resulting from collision between the pulverization media and/or collision between the pulverizer and the pulverization media. As the pulverization device, a known pulverization device such as a high-speed rotary impact mill, a jet mill, a roll mill, an attritor, a ball mill, a vibration mill, or a bead mill can be used.

During the pulverization, various types of vapor or gas can be blown into the pulverizer to further activate the surface of the carbon nanotube (B) or adjust the activity. The vapor is preferably an acidic or basic compound or the like, and the gas is preferably oxygen, nitrogen, or the like.

The outer diameter of the pulverization media is preferably 0.1 mm to 5 mm, more preferably 0.5 mm to 3 mm. Within this range, a desired pulverization force is provided, and the pigment can be efficiently pulverized and disintegrated without excessively destroying the fiber shape of the carbon nanotube.

### (Moisture Adsorption Properties of Carbon Nanotube)

The carbon nanotube (B) is known to adsorb water in the air during the processes of production and storage of the carbon nanotube, production and storage of various pastes, etc., but in the present invention, the carbon nanotube preferably does not adsorb water during the processes. The amount of water adsorption (the amount of moisture adsorption) on the carbon nanotube (B) relative to the humidity in the air depends on, for example, the humidity, the surface area of the carbon nanotube, and the surface property (hydrophilicity) of the carbon nanotube.

When the amount of moisture adsorption on the carbon nanotube (B) under certain conditions is Y (mass %) and the BET specific surface area of the carbon nanotube (B) is Z (m²/g), it is preferable that the upper limit of the moisture adsorption properties X obtained by X=Y×Z is typically 1000 or less, preferably 500 or less, more preferably 300 or less, and the lower limit is typically 10 or more, preferably 50 or more, more preferably 100 or more. The present inventors have found that within this range, the amount of water adsorption on the carbon nanotube (B) is reduced, whereby viscosity increase and gelation of the pastes can be suppressed, and dispersibility (adsorption on a dispersant) can be simultaneously achieved.

The amount of moisture adsorption Y is determined under the following measurement conditions.

### [Conditions for Measurement of Amount of Moisture Adsorption Y]

When the mass of the carbon nanotube dried at a temperature of 140° C. for 3 hours is Y1, and the mass of the conductive carbon further left to stand at a temperature of 20° C. and a relative humidity of 65% for 24 hours is Y2, the value (mass %) of Y obtained by the following formula is the amount of moisture adsorption Y.

$$Amount of moisture adsorption Y = ( Y 2 - Y 1 ) / Y 1 \times 100$$

### Other Conductive Pigment (B1)

In the carbon nanotube dispersion paste used in the present invention, any other conductive pigment (B1) other than the carbon nanotube (B) can be used in combination. The other conductive pigment (B1) may be, for example, at least one conductive carbon selected from the group consisting of acetylene black, ketjen black, furnace black, thermal black, graphene, and graphite. Preferred are one or more selected from the group consisting of acetylene black, ketjen black, furnace black, and thermal black, more preferred are one or more selected from the group consisting of acetylene black and ketjen black, and still more preferred is acetylene black.

The average primary particle diameter of the other conductive pigment (B1) is, for example, 10 nm or more, preferably 20 nm or more, and is, for example, 80 nm or less, more preferably 70 nm or less. Herein, the term “average primary particle diameter” refers to an average particle diameter of primary particles determined as follows: the conductive pigment (B1) is observed under an electron microscope; projected areas of 100 particles are determined; diameters of imaginary circles having areas equal to the projected areas are determined; and the diameters of the 100 particles are simply averaged. When the pigment is in an aggregated state, calculations are conducted using primary particles constituting an aggregate particle.

The BET specific surface area of the other conductive pigment (B1) is not particularly limited. In terms of viscosity and conductivity, it is, for example, 1 m²/g or more, preferably 10 m²/g or more, more preferably 20 m²/g or more, and is, for example, 500 m²/g or less, preferably 250 m²/g or less, more preferably 200 m²/g or less.

The dibutyl phthalate (DBP) absorption of the other conductive pigment (B1) is not particularly limited. In terms of pigment dispersibility and conductivity, it is, for example, 60 ml/100 g or more, preferably 150 ml/100 g or more, and is, for example, 1,000 ml/100 g or less, preferably 800 ml/100 g or less.

### Solvent (C)

The solvent (C) has a water content of less than 10000 ppm, and organic solvents can be suitably used. Specific examples include hydrocarbon solvents such as n-butane, n-hexane, n-heptane, n-octane, cyclopentane, cyclohexane, and cyclobutane; aromatic solvents such as toluene and xylene; ketone solvents such as methyl isobutyl ketone; ether solvents such as n-butyl ether, dioxane, ethylene glycol monomethyl ether, ethylene glycol monoethyl ether, ethylene glycol monoethyl ether, ethylene glycol monobutyl ether, and diethylene glycol; ester solvents such as ethyl acetate, n-butyl acetate, isobutyl acetate, ethylene glycol monomethyl ether acetate, and butyl carbitol acetate; ketone solvents such as methyl ethyl ketone, methyl isobutyl ketone, and diisobutyl ketone; alcohol solvents such as ethanol, isopropanol, n-butanol, sec-butanol, and isobutanol; and amide solvents such as EQUAMIDE (amide solvent, manufactured by Idemitsu Kosan Co., Ltd., trade name), N,N-dimethylformamide, N,N-dimethylacetamide, N-methylformamide, N-methylacetamide, N-methylpropioamide, and N-methyl-2-pyrrolidone.

In particular, amide solvents are preferred, and N-methyl-2-pyrrolidone is more preferred. These solvents can be used alone or in combination of two or more.

The water content of the solvent (C) is typically less than 10000 ppm, preferably less than 7500 ppm, more preferably less than 5000 ppm, still more preferably less than 2500 ppm, particularly preferably less than 1000 ppm.

When an amide compound (solvent) such as N-methyl-2-pyrrolidone is used, an amine component may be contained as an impurity, and in the carbon nanotube dispersion paste of the present invention, the viscosity or the tendency of viscosity increase may vary from lot to lot depending on the amine component as an impurity.

When the carbon nanotube dispersion paste of the present invention is applied to an electrode layer by a method described later, the solvent and the like volatilize and thus will not remain, but it is preferable to recover and reuse the volatilized solvent for waste reduction, environmental friendliness, and/or raw material cost reduction. That is, it is preferable to use a regenerated product as the solvent (C). This regenerated solvent (regenerated product), when the carbon nanotube dispersion paste of the present invention contains an amine compound (E1), also contains the originally contained amine compound, and the viscosity or the tendency of viscosity increase of the paste also varies from lot to lot. The amine compound often has a strong odor.

Therefore, in this case, the amine compound content in the solvent (C) as a regenerated product is preferably controlled and regulated at or below a certain level, and it is preferable that the amine compound content is typically 1 mass % or less, preferably 0.5 mass % or less, particularly preferably 0.1 mass % or less.

The amine compound content can be quantitatively determined by a commonly used analysis such as ion chromatography-mass spectrometry (IC-MS). The content can be quantitatively determined by preliminarily preparing a calibration curve for the peak of an amine species expected to enter.

The above phrase “use a regenerated product as the solvent (C)” means that the regenerated product is included in an amount of 5 mass % or more (preferably 10 mass % or more) in the solvent (C) used in the present invention. As the regenerated product, a solvent recovered during the process of producing an electrode layer by heating and drying a mixture paste described later is preferably used.

When a regenerated product is used as the solvent (C) and the carbon nanotube dispersion paste of the present invention contains a highly polar low-molecular-weight component (E) described later, it is necessary to remove the highly polar low-molecular-weight component (E) in the solvent (C). Thus, when the boiling point of the solvent (C) is (Xc)° C., and the boiling point of the highly polar low-molecular-weight component (E) is (Xe)° C., (Xc)−10>(Xe) preferably holds, and (Xc)−15>(Xe) preferably holds from the viewpoint of distillation (removal of the highly polar low-molecular-weight component (E)).

As the solvent (C), N-methyl-2-pyrrolidone is preferably contained, and when N-methyl-2-pyrrolidone is contained, it is preferable to use a regenerated product of N-methyl-2-pyrrolidone. Furthermore, it is preferable to control the water content in N-methyl-2-pyrrolidone at less than 10000 ppm (preferably less than 7500 ppm, more preferably less than 5000 ppm, still more preferably less than 2500 ppm, particularly preferably less than 1000 ppm).

As the highly polar low-molecular-weight component (E), the amine compound (E1) is preferably contained.

The content of the solvent (C) in the carbon nanotube dispersion paste is, for example, 40 mass % or more, preferably 60 mass % or more, more preferably 80 mass % or more, and is, for example, 99 mass % or less, preferably 98 mass % or less, more preferably 97 mass % or less, based on 100 mass % of the total amount of the carbon nanotube dispersion paste.

The solid content of the carbon nanotube dispersion paste is, for example, 1 mass % or more, preferably 2 mass % or more, more preferably 3 mass % or more, and is, for example, 60 mass % or less, preferably 40 mass % or less, more preferably 20 mass % or less, based on 100 mass % of the total amount of the carbon nanotube dispersion paste.

### Polyvinylidene Fluoride (D)

The polyvinylidene fluoride (D), which is a resin used for the purpose of film formation of an electrode layer, can be optionally contained in the carbon nanotube dispersion paste of the present invention, and is preferably contained. It is a component essential to the mixture paste described later.

A modified polyvinylidene fluoride (D1) which is variously modified can also be suitably used, and preferably has a polar functional group from the viewpoint of adhesion to a substrate.

The weight-average molecular weight of the polyvinylidene fluoride (D) is, for example, 100,000 or more, preferably 500,000 or more, more preferably 650,000 or more, and is, for example, 3,000,000 or less, preferably 2,000, 000 or less, from the viewpoint of adhesion to a substrate, enhancement of film physical properties, and solvent resistance.

The content of the polyvinylidene fluoride (D), if contained, is, for example, 10.0 mass % or more, preferably 30.0 mass % or more, more preferably 40.0 mass % or more, and is, for example, 99.0 mass % or less, preferably 80.0 mass or less, more preferably 60.0 mass % or less, based on 100 mass % of the solid content of the carbon nanotube dispersion paste. The content of the polyvinylidene fluoride (D) is, for example, 0.1 mass % or more, preferably 0.5 mass % or more, more preferably 1 mass % or more, and is, for example, 10 mass % or less, preferably 7 mass % or less, more preferably 5 mass % or less, based on 100 mass % of the total amount of the carbon nanotube dispersion paste.

The step of converting the polyvinylidene fluoride (D) from a solid state into a resin solution preferably includes, from the viewpoint of solvent solubility, a step of mixing and dissolving the polyvinylidene fluoride (D) in advance with a solvent having a liquid temperature of 40° C. or higher (preferably 60° C. or higher, more preferably 80° C. or higher) (the upper limit is 200° C. or lower, preferably 100° C. or lower) to be converted into a resin solution, and other components [e.g., the components (A), (B), and (C)] are preferably mixed after the conversion into the resin solution.

The “liquid temperature” is the temperature of the solvent or the resin solution at the time of dissolution.
The polyvinylidene fluoride (D) in a solid state may be mixed and dissolved in a solvent at 40° C. or higher in advance, or the polyvinylidene fluoride (D) in a solid state may be mixed with a solvent and then heated to a temperature of 40° C. or higher.
Components other than the polyvinylidene fluoride (D) and the solvent may be contained.
The solvent for use may be a single solvent or a combination of two or more solvents, and those listed in Solvent (C) given above can be suitably used.
The resin solution obtained through thermal dissolution as described above is preferably cooled to a predetermined temperature of 10° C. or higher and lower than 40° C., and this cooling step is preferably carried out such that the cooling rate defined by the following formula:

$$Cooling rate = ( solution temperature at the start of cooling - solution temperature at the end of cooling ) / cooling time is 0.5 ° C . / min or more ( preferably 1 ° C . / min or more ) from the viewpoint of preventing precipitation .$$

### Mixing and Dispersing

In the production method according to the present invention, the step of mixing and dispersing is a step of mixing components including a dispersing resin (A) having a heterocyclic ring and/or an alkyl group having 12 or more carbon atoms, a carbon nanotube (B), a solvent (C) having a water content of less than 10000 ppm, and polyvinylidene fluoride (D) that can be optionally included and further performing dispersion, and can provide a liquid carbon nanotube dispersion paste.

The upper limit of the solid concentration of the carbon nanotube dispersion paste is typically less than 80 mass %, preferably less than 50 mass %, more preferably less than 20 mass %, still more preferably less than 10 mass %. The lower limit is typically 0.1 mass % or more, preferably 0.5 mass % or more, more preferably 1 mass % or more, still more preferably 2 mass % or more.

In the mixing and dispersing step, the components are uniformly mixed and dispersed using, for example, a conventionally known disperser such as a paint shaker, a sand mill, a ball mill, a pebble mill, an LMZ mill, a DCP pearl mill, a planetary ball mill, a homogenizer, a twin-screw kneader, or a thin-film spin system high-speed mixer (manufactured by FILMIX Corporation, trade name “CLEARMIX” or the like), whereby the carbon nanotube dispersion paste can be prepared. The order of mixing of the components is not particularly limited.

The step of mixing and dispersing preferably includes a step of sequentially performing
Step 1: a step of adding the components into a disperser, the components including the carbon nanotube (B) in an amount of 70 mass % or less (preferably 50 mass % or less) based on 100 mass % of the total amount of the carbon nanotube (B) contained in the carbon nanotube dispersion paste obtained after dispersion, and performing dispersion treatment, and
Step 2: a step of adding the carbon nanotube (B) into the disperser until a desired concentration is reached, and performing dispersion treatment.
   The dispersion treatment time in the step 1 is preferably at least 30 seconds or more (preferably 1 minute or more).
   By performing the above mixing and dispersing, a paste in which aggregation of the carbon nanotube (B) is alleviated and which is well-dispersed and homogeneous even if it is a high-concentration paste is provided, and a battery electrode layer (coating film) thereof is excellent in finish quality, conductivity, battery performance, etc.

### Highly Polar Low-Molecular-Weight Component (E)

The carbon nanotube dispersion paste can further contain a highly polar low-molecular-weight component (E). The highly polar low-molecular-weight component (E) is a component that increases the wettability and/or storage stability of the conductive pigment, and examples include basic components and acidic components known per se, among which an amine compound (E1) is preferably contained.

The content of the amine compound (E1) in the highly polar low-molecular-weight component (E) is, for example, 50 mass % or more, preferably 75 mass % or more, more preferably 95 mass % or more, based on 100 mass % of the highly polar low-molecular-weight component (E).

Examples of the amine compound (E1) include ammonia, primary amines, secondary amines, and tertiary amines.

Examples of primary amines include primary monoamines such as ethylamine, n-propylamine, sec-propylamine, n-butylamine, sec-butylamine, i-butylamine, tert-butylamine, pentylamine, hexylamine, heptylamine, octylamine, decylamine, laurylamine, myristylamine, 1,2-dimethylhexylamine, 3-pentylamine, 2-ethylhexylamine, allylamine, aminoethanol, 1-aminopropanol, 2-aminopropanol, aminobutanol, aminopentanol, aminohexanol, 3-ethoxypropylamine, 3-propoxypropylamine, 3-isopropoxypropylamine, 3-butoxypropylamine, 3-isobutoxypropylamine, 3-(2-ethylhexyloxy)propylamine, aminocyclopentane, aminocyclohexane, aminonorbornene, aminomethylcyclohexane, aminobenzene, benzylamine, phenethylamine, α-phenylethylamine, naphthylamine, and furfurylamine; and primary polyamines such as ethylenediamine, 1,2-diaminopropane, 1,3-diaminopropane, 1,2-diaminobutane, 1,3-diaminobutane, 1,4-diaminobutane, 1,5-diaminopentane, 1,6-diaminohexane, 1,7-diaminoheptane, 1,8-diaminooctane, dimethylaminopropylamine, diethylaminopropylamine, bis-(3-aminopropyl)ether, 1,2-bis-(3-aminopropoxy)ethane, 1,3-bis-(3-aminopropoxy)-2,2′-dimethylpropane, aminoethylethanolamine, 1,2-bisaminocyclohexane, 1,3-bisaminocyclohexane, 1,4-bisaminocyclohexane, 1,3-bisaminomethylcyclohexane, 1,4-bisaminomethylcyclohexane, 1,3-bisaminoethylcyclohexane, 1,4-bisaminoethylcyclohexane, 1,3-bisaminopropylcyclohexane, 1,4-bisaminopropylcyclohexane, hydrogenated 4,4′-diaminodiphenylmethane, 2-aminopiperidine, 4-aminopiperidine, 2-aminomethylpiperidine, 4-aminomethylpiperidine, 2-aminoethylpiperidine, 4-aminoethylpiperidine, N-aminoethylpiperidine, N-aminopropylpiperidine, N-aminoethylmorpholine, N-aminopropylmorpholine, isophoronediamine, menthanediamine, 1,4-bisaminopropylpiperazine, o-phenylenediamine, m-phenylenediamine, p-phenylenediamine, 2,4-tolylenediamine, 2,6-tolylenediamine, 2,4-toluenediamine, m-aminobenzylamine, 4-chloro-o-phenylenediamine, tetrachloro-p-xylylenediamine, 4-methoxy-6-methyl-m-phenylenediamine, m-xylylenediamine, p-xylylenediamine, 1,5-naphthalenediamine, 2,6-naphthalenediamine, benzidine, 4,4′-bis(o-toluidine), dianisidine, 4,4′-diaminodiphenylmethane, 2,2-(4,4′-diaminodiphenyl)propane, 4,4′-diaminodiphenyl ether, 4,4′-thiodianiline, 4,4′-diaminodiphenylsulfone, 4,4′-diaminoditolylsulfone, methylenebis(o-chloroaniline), 3,9-bis(3-aminopropyl)2,4,8,10-tetraoxaspiro[5,5]undecane, diethylenetriamine, iminobispropylamine, methyliminobispropylamine, bis(hexamethylene)triamine, triethylenetetramine, tetraethylenepentamine, pentaethylenehexamine, N-aminoethylpiperazine, N-aminopropylpiperazine, 1,4-bis(aminoethylpiperazine), 1,4-bis(aminopropylpiperazine), 2,6-diaminopyridine, and bis(3,4-diaminophenyl)sulfone.

Examples of secondary amines include secondary monoamines such as diethylamine, dipropylamine, di-n-butylamine, di-sec-butylamine, diisobutylamine, di-n-pentylamine, di-3-pentylamine, dihexylamine, dioctylamine, di(2-ethylhexyl)amine, methylhexylamine, diallylamine, pyrrolidine, piperidine, 2,4-lupetidine, 2,6-lupetidine, 3,5-lupetidine, diphenylamine, N-methylaniline, N-ethylaniline, dibenzylamine, methylbenzylamine, dinaphthylamine, pyrrole, indoline, indole, and morpholine; and secondary polyamines such as N,N′-dimethylethylenediamine, N,N′-dimethyl-1,2-diaminopropane, N,N′-dimethyl-1,3-diaminopropane, N,N′-dimethyl-1,2-diaminobutane, N,N′-dimethyl-1,3-diaminobutane, N,N′-dimethyl-1,4-diaminobutane, N,N′-dimethyl-1,5-diaminopentane, N,N′-dimethyl-1,6-diaminohexane, N,N′-dimethyl-1,7-diaminoheptane, N,N′-diethylethylenediamine, N,N′-diethyl-1,2-diaminopropane, N,N′-diethyl-1,3-diaminopropane, N,N′-diethyl-1,2-diaminobutane, N,N′-diethyl-1,3-diaminobutane, N,N′-diethyl-1,4-diaminobutane, N,N′-diethyl-1,6-diaminohexane, piperazine, 2-methylpiperazine, 2,5-dimethylpiperazine, 2,6-dimethylpiperazine, homopiperazine, 1,1-di-(4-piperidyl)methane, 1,2-di-(4-piperidyl)ethane, 1,3-di-(4-piperidyl)propane, and 1,4-di-(4-piperidyl)butane.

Examples of tertiary amines include tertiary monoamines such as trimethylamine, triethylamine, tri-n-propylamine, tri-iso-propylamine, tri-1,2-dimethylpropylamine, tri-3-methoxypropylamine, tri-n-butylamine, tri-iso-butylamine, tri-sec-butylamine, tri-pentylamine, tri-3-pentylamine, tri-n-hexylamine, tri-n-octylamine, tri-2-ethylhexylamine, tri-dodecylamine, tri-laurylamine, dicyclohexylethylamine, cyclohexyldiethylamine, tri-cyclohexylamine, N,N-dimethylhexylamine, N-methyldihexylamine, N,N-dimethylcyclohexylamine, N-methyldicyclohexylamine, N,N-diethylethanolamine, N,N-dimethylethanolamine, N-ethyldiethanolamine, triethanolamine, tribenzylamine, N,N-dimethylbenzylamine, diethylbenzylamine, triphenylamine, N,N-dimethylamino-p-cresol, N,N-dimethylaminomethylphenol, 2-(N,N-dimethylaminomethyl)phenol, N,N-dimethylaniline, N,N-diethylaniline, pyridine, quinoline, N-methylmorpholine, N-methylpiperidine, 2-(2-dimethylaminoethoxy)-4-methyl-1,3,2-dioxaborinane, and 2-, 3-, 4-picoline; and tertiary polyamines such as tetramethylethylenediamine, pyrazine, N,N′-dimethylpiperazine, N,N′-bis((2-hydroxy) propyl) piperazine, hexamethylenetetramine, N,N,N′,N′-tetramethyl-1,3-butaneamine, 2-dimethylamino-2-hydroxypropane, diethylaminoethanol, N,N,N-tris(3-dimethylaminopropyl)amine, 2,4,6-tris(N,N-dimethylaminomethyl)phenol, and heptamethylisobiguanide.

These can be used alone or in combination of two or more.

In particular, primary amine compounds are preferred, and monovalent amine compounds (monoamines) are preferred.

Examples of the amine compound (E1) include aliphatic amines, alicyclic amines, aromatic amines, and alkanolamines, any of which can be suitably used, and aromatic amines are preferred.

Since the amine compound preferably does not remain in an electrode layer after drying, the weight-average molecular weight of the amine compound (E1) is preferably less than 1,000, more preferably 800 or less, still more preferably 500 or less, particularly preferably 350 or less, further particularly preferably 250 or less. For the same reason, the boiling point of the amine compound is preferably 400° C. or lower, more preferably 300° C. or lower, still more preferably 200° C. or lower.

When the boiling point is low, the amine compound may volatilize during production or storage, and furthermore, from the viewpoint of odors, the lower limit is preferably 50° C. or higher, more preferably 100° C. or higher.

The amine value of the amine compound (E1) is typically 5 mgKOH/g or more, preferably 50 mgKOH/g or more, more preferably 105 mgKOH/g or more, and is typically in the range of 1,000 mgKOH/g or less.

As other highly polar low-molecular-weight components used in combination with the amine compound (E1), for example, acidic highly polar low-molecular-weight components selected from organic acids and inorganic acids can be used alone or in combination of two or more. Furthermore, basic highly polar low-molecular-weight components selected from organic bases and inorganic bases can be used alone or in combination of two or more.

Examples of organic acids include organic carboxylic acids (e.g., formic acid, acetic acid, propionic acid, benzoic acid, and phthalic acid) and organic sulfonic acids (e.g., benzenesulfonic acid), and examples of inorganic acids include hydrochloric acid, sulfuric acid, nitric acid, and phosphoric acid. Acid anhydrides thereof can also be used.

Examples of organic bases include basic components other than amine compounds, and examples of inorganic bases include metal hydroxides (e.g., sodium hydroxide and potassium hydroxide).

It is preferable that the content of the highly polar low-molecular-weight component (E) is, for example, 1 mass % or more, preferably 1.5 mass % or more, more preferably 2 mass % or more, and is, for example, 600 mass % or less, preferably 300 mass % or less, more preferably 50 mass % or less, based on 100 mass % of the solid content of the carbon nanotube dispersion paste.

Based on 100 mass % of the solid content of the carbon nanotube (B), the lower limit is, for example, 1 mass % or more, preferably 2 mass % or more, more preferably 5 mass or more. The upper limit is, for example, 1,000 mass % or less, preferably 500 mass % or less, more preferably 50 mass or less.
Based on 100 mass % of the total amount of the carbon nanotube dispersion paste, the lower limit is, for example, 0.01 mass % or more, preferably 0.05 mass % or more, more preferably 0.1 mass % or more. The upper limit is, for example, 10 mass % or less, preferably 5 mass % or less, more preferably 1 mass % or less.

The highly polar low-molecular-weight component (E) [particularly, the amine compound (E1)] often has a strong odor and thus may deteriorate the working environment at the time of blending or during the process of drying. In addition, it is generally expensive and thus may lead to an increased cost. Therefore, its content needs to be minimized.

It is preferable that the content ratio of the solvent (C) to the highly polar low-molecular-weight component (E), in terms of the mass ratio of the solvent (C) to the highly polar low-molecular-weight component (E), is typically in the range of 100/0.01 to 100/10, preferably in the range of 100/0.02 to 100/7, more preferably in the range of 100/0.05 to 100/5, still more preferably in the range of 100/0.1 to 100/4.

When the carbon nanotube dispersion paste used in the production method according to the present invention contains the highly polar low-molecular-weight component (E), the value of X represented by the following formula (2) where α (parts by mass) is the content of the highly polar low-molecular-weight component (E) relative to 100 parts by mass of the content of the carbon nanotube (B), and β (m²/g) is the BET specific surface area of the carbon nanotube (B), is typically 1 or more, preferably 5 or more, more preferably 10 or more, and is typically 2,500 or less, preferably 1,000 or less, more preferably 300 or less, still more preferably in the range of 100 or less.

$$X = α / β \times 300 \qquad Formula ( 2 )$$

It has been found that within this range, the surface of the carbon nanotube (B) can be wetted with the highly polar low-molecular-weight component (E) to a necessary and sufficient extent, and the dispersibility (including viscosity) and storage stability (including viscosity increase suppression) of the carbon nanotube (B) can be improved.

When above the upper limit range, the highly polar low-molecular-weight component (E) content relative to the surface area of the carbon nanotube (B) is excessive (odor and cost increase), and when below the lower limit range, the highly polar low-molecular-weight component (E) content relative to the surface area of the carbon nanotube (B) is insufficient.

When the carbon nanotube dispersion paste used in the production method according to the present invention contains the carbon nanotube (B) and the amine compound (E1), the value of Y represented by the following formula (3) where α (parts by mass) is the content of the amine compound (E1) relative to 100 parts by mass of the content of the carbon nanotube (B), β (m²/g) is the BET specific surface area of the carbon nanotube (B), and γ (mmol/g) is the acidic group content of the carbon nanotube (B), is preferably 0.01 or more, more preferably 0.05 or more, still more preferably 0.1 or more, particularly preferably 1 or more. The preferred range is preferably 0.01 or more and 400 or less, more preferably 0.05 or more and 100 or less, still more preferably 0.1 or more and 75 or less, particularly preferably 1 or more and 50 or less.

$$Y = α / β / γ \qquad Formula ( 3 )$$

It has been found that within this range, the surface of the carbon nanotube (B) having a certain amount of acidic groups can be wetted with the amine compound (E1) to a necessary and sufficient extent, and the dispersibility (including viscosity) and storage stability (including viscosity increase suppression) of the carbon nanotube (B) can be improved.

If the content of the amine compound (E1) relative to the surface area of the carbon nanotube (B) having acidic groups is excessive, the odor becomes strong, and the cost increases. If the content is insufficient, the amine compound (E1) content relative to the surface area of the carbon nanotube (B) having acidic groups may be insufficient, leading to poor dispersibility and poor storage stability (viscosity increase suppression).

### Other Components

The carbon nanotube dispersion paste can further contain other components in addition to the components (A), (B), and (C) and the components (D) and (E) which can be optionally contained.

Examples of the other components include resins other than the dispersing resin (A) and the polyvinylidene fluoride (D), neutralizers, antifoaming agents, antiseptics, anticorrosives, plasticizers, pigments other than the carbon nanotube (B), and a dehydrating agent (F).

Examples of the pigments other than the carbon nanotube (B) include the other conductive pigment (B1) described above; white pigments such as titanium white and zinc white; blue pigments such as cyanine blue and indanthrene blue; green pigments such as cyanine green and verdigris; red pigments such as colcothar and organic red pigments such as azo pigments and quinacridone pigments; and yellow pigments such as titanium yellow, chrome yellow, and organic yellow pigments such as benzimidazolone pigments, isoindolinone pigments, isoindoline pigments, and quinophthalone pigments. These pigments can be used alone or in combination of two or more.

These pigments other than the carbon nanotube (B) can be used for the purpose of, for example, color adjustment and enhancement of film physical properties without greatly impairing conductivity, and may be dispersed simultaneously with the dispersing resin (A) and the carbon nanotube (B) or may be mixed in the form of a pigment or a pigment paste after the dispersing resin (A) and the carbon nanotube (B) are dispersed to prepare a paste.

The content of the pigments other than the carbon nanotube (B) is preferably 10 mass % or less, more preferably 5 mass % or less, still more preferably 1 mass % or less, particularly preferably substantially zero, based on 100 mass % of all the pigments in the carbon nanotube dispersion paste.

For the viscosity of the carbon nanotube dispersion paste, from the viewpoint of, for example, pigment dispersibility and storage stability, the viscosity at a shear rate of 2 s⁻¹ is, for example, less than 5,000 mPa·s, preferably less than 2, 500 mPa·s, more preferably less than 1,000 mPa·s, and is, for example, 10 mPa·s or more, preferably 50 mPa·s or more, more preferably 100 mPa·s or more. The viscosity can be measured using, for example, a cone & plate viscometer (manufactured by HAAKE, trade name “Mars2”, a cone & plate with a diameter of 35 mm and an inclination of 2°).

As the dehydrating agent (F), any known dehydrating agent having dehydrating action can be used without any particular limitation. A solid dehydrating agent that is not soluble in the solvent (C) in the paste may be used, or a dehydrating agent that is soluble in the solvent (C) may be used. Specific examples include solid dehydrating agents such as zeolite, silica gel, calcium oxide, molecular sieve, activated alumina, barium oxide, calcium hydride, and sodium sulfate; phosphoric acid esters such as trimethyl phosphate, tri-2-propyl phosphate, tributyl phosphate, and tetraisopropylethylene phosphonate; phosphine oxides such as tributylphosphine oxide, trioctylphosphine oxide, and triphenylphosphine oxide; ortho esters such as methyl orthoformate ester, ethyl orthoformate ester, methyl orthoacetate ester, ethyl orthoacetate ester, and ethyl orthobenzoate ester; and acid anhydrides such as oxalic anhydride, acetic anhydride, propionic anhydride, butyric anhydride, benzoic anhydride, trifluoroacetic anhydride, disulfuric acid, dinitrogen pentoxide, diphosphoric acid, diphosphorus pentoxide, diphosphorus trioxide, diarsenic pentoxide, diarsenic trioxide, methanesulfonic anhydride, trifluoromethanesulfonic anhydride, and sulfobenzoic anhydride, and these can be used alone or in combination of two or more.

### [Method for Producing Mixture Paste (for Lithium Ion Secondary Battery)]

In the production method according to the present invention, first, a carbon nanotube dispersion paste containing the carbon nanotube (B) is prepared by the above-described method. Furthermore, the carbon nanotube dispersion paste and at least one electrode active material (G) are mixed, whereby a mixture paste for a lithium ion secondary battery can be produced.

In terms of battery performance, it is preferable that the solid content of the electrode active material (G) is typically 10 mass % or more, preferably 20 mass % or more, and is typically 99 mass % or less, preferably 95 mass % or less, based on 100 mass % of the total amount of the mixture paste. The polyvinylidene fluoride (D), which is an optional component in the carbon nanotube dispersion paste, is an essential component in the mixture paste and is always contained.

In terms of battery performance, paste viscosity, etc., it is preferable that the solid content of the polyvinylidene fluoride (D) is typically 0.05 mass % or more, preferably 0.1 mass % or more, and is typically 10 mass % or less, preferably 2 mass % or less, based on 100 mass % of the total amount of the mixture paste.

In the above step of mixing the electrode active material (G), the mixture paste can be uniformly mixed using a mixer and a disperser known in the art.

In terms of battery performance, paste viscosity, etc., it is preferable that the solid content of the dispersing resin (A) in the solid of the mixture paste is typically 0.01 mass % or more, preferably 0.05 mass % or more, and is typically 10 mass % or less, preferably 1 mass % or less, based on 100 mass % of the total amount of the mixture paste.

From the viewpoint of storage stability (viscosity increase suppression) of the mixture paste, the mixture paste of the present invention contains the highly polar low-molecular-weight component (E), and at least one amine compound (E1) is preferably contained as the highly polar low-molecular-weight component (E).

Since bringing the highly polar low-molecular-weight component (E) into contact with the carbon nanotube (B) (to be wet) and then mixing the electrode active material (G) alleviates aggregation of the carbon nanotube (B) and the electrode active material (G), the carbon nanotube (B) and the highly polar low-molecular-weight component (E) are mixed first. This order of mixing is preferably included.

In terms of battery performance, it is preferable that the solid content of the carbon nanotube (B) in the solid of the mixture paste of the present invention is typically 0.01 mass % or more, preferably 0.05 mass % or more, more preferably 0.1 mass % or more, and is typically 30 mass % or less, preferably 10 mass % or less, more preferably 5 mass or less, based on 100 mass % of the total amount of the mixture paste. In terms of electrode drying efficiency and paste viscosity, it is preferable that the content of the solvent (C) in the mixture paste of the present invention is typically 1 mass % or more, preferably 4 mass % or more, more preferably 7 mass % or more, and is typically 90 mass or less, preferably 70 mass % or less, more preferably 50 mass or less, based on 100 mass % of the total amount of the mixture paste.

The mixture paste is suitable for use for a positive electrode or a negative electrode for a lithium ion secondary battery electrode, and is preferably suitable for use for a positive electrode.

From the viewpoint of suppressing the above-described viscosity increase or gelation of the mixture paste, the water content of the mixture paste is typically less than 10000 ppm, preferably less than 7500 ppm, more preferably less than 5000 ppm, still more preferably less than 2500 ppm, particularly preferably less than 1000 ppm.

The mixture paste used in the present invention can be said to be a substantially nonaqueous mixture paste.
For the above-described reasons (the introduction of water from raw materials and the entry of water during the production process), the water content of the mixture paste is preferably 100 ppm or more, more preferably 200 ppm or more, still more preferably 500 ppm or more.

### Electrode Active Material (G)

Examples of the electrode active material (G) include lithium composite oxides such as lithium nickel oxide (LiNiO₂), lithium manganese oxide (LiMn₂O₄), lithium cobalt oxide (LiCoO₂), and LiNi_{1/3}Co_{1/3}Mn_{1/3}O₂; lithium iron phosphate (LiFePO₄); sodium composite oxides; and potassium composite oxides. These electrode active materials (G) can be used alone or in combination of two or more. The electrode active material containing lithium iron phosphate is inexpensive and has relatively good cycle characteristics and energy density, and thus can be suitably used.

The particle diameter of the electrode active material (G) is typically 0.5 μm or more, preferably 10.5 μm or more, and is typically 30 μm or less, preferably 20 μm or less.

In terms of battery capacity, battery resistance, etc., it is preferable that the solid content of the electrode active material (G) in 100 mass % of the solid of the mixture paste for a lithium ion secondary battery electrode of the present invention is typically 50 mass % or more, preferably 60 mass % or more, and is less than 100 mass.

When the electrode active material (G) is contained in the mixture paste, the viscosity may increase during storage. This is probably because the electrode active material (G) has, on its particle surface, an alkali metal hydroxide (e.g., LiOH, KOH, or NaOH) derived from a raw material and thus aggregates (becomes more viscous) due to the carbon nanotube (B) which has an acidic surface. Therefore, the presence of the highly polar low-molecular-weight component (E) [particularly, the amine compound (E1)] in a certain amount or more can suppress the viscosity increase during storage of the mixture paste.

From the viewpoint of suppressing the above-described viscosity increase or gelation of the mixture paste, the water content in the electrode active material (G) is typically less than 10000 ppm, preferably less than 7500 ppm, more preferably less than 5000 ppm, still more preferably less than 2500 ppm, particularly preferably less than 1000 ppm.

As the electrode active material (G) of the present invention, an electrode active material composite (G-1) obtained by covering at least a part of a surface of the electrode active material (G) with a carbon nanotube can be suitably used.
The composite (G-1) can be obtained by mixing the electrode active material (G), the carbon nanotube, and optional other components (e.g., a solvent and a dispersing resin) in advance, and a drying step can be performed after the mixing as required, so that the carbon nanotube can be more uniformly adsorbed and/or fixed on the electrode active material (G).
Since the carbon nanotube is adsorbed and/or fixed on the surface of the electrode active material, the electrode active material composite (G-1) produced as described above can form a uniform conductive network around the electrode active material.
As the carbon nanotube used in the electrode active material composite (G-1), a carbon nanotube known per se can be used without any particular limitation, and the carbon nanotube mentioned as the carbon nanotube (B) can be suitably used.

### Method for Producing Electrode Layer for Lithium Ion Secondary Battery

As described above, an electrode layer (also referred to as an electrode mixture layer or a mixture layer) for a lithium ion secondary battery can be produced by applying a mixture paste for a lithium ion secondary battery to the surface of the core (current collector) of a positive electrode or a negative electrode and drying the mixture paste, and is preferably used particularly for a positive electrode.

The carbon nanotube dispersion paste obtained by the production method according to the present invention can be used not only as a paste for a mixture layer (electrode layer) but also as a primer layer (also called a functional layer or an adhesive layer) between an electrode core and a mixture layer (electrode layer).

The application of the mixture paste for a lithium ion secondary battery can be carried out by a method known per se using a die coater or the like. The amount of application of the mixture paste for a lithium ion secondary battery is not particularly limited, and can be set so that the thickness of the dried mixture layer will be in the range of, for example, 0.04 mm or more, preferably 0.06 mm or more, and, for example, 0.30 mm or less, preferably 0.24 mm or less. The temperature of the drying step can be appropriately set in the range of, for example, 80° C. or higher, preferably 100° C. or higher, and, for example, 250° C. or lower, preferably 200° C. or lower. The duration of the drying step can be appropriately set in the range of, for example, 5 seconds or more and, for example, 120 minutes or less, preferably 60 minutes or less.

Although the whole or part of the solvent (C) and the highly polar low-molecular-weight component (E) which can be optionally contained volatilize in the drying step, it is preferable to recover and reuse the volatilized components (C) and (E) for waste reduction, environmental friendliness, and/or cost reduction, as described above.

A lithium ion secondary battery has a problem that its cycle life decreases if impurities such as water are present in an electrode layer. That is, if the carbon nanotube dispersion paste or the mixture paste contains more water than the specified amount, or drying is insufficiently performed in the process of producing the electrode layer, water remains in the electrode layer, causing degradation of cycle characteristics of the battery. The water content in the electrode layer is typically less than 1000 ppm, preferably less than 750 ppm, more preferably less than 500 ppm, still more preferably less than 250 ppm, particularly preferably less than 100 ppm.

As described above, when the mixture paste is applied onto a current collector and dried by heating, a vapor containing the solvent (C) [optionally, the highly polar low-molecular-weight component (E)] and others is recovered, and then impurities other than the solvent (C) are removed by distillation, whereby a regenerated product of the solvent (C) can be produced.

After the electrode layer is formed by applying the mixture paste onto the current collector in a strip shape, an insulating paste can be applied to form an electrode insulating portion for the purpose of insulation of an end portion or an upper layer of the electrode layer.

As the insulating paste, any paste that can provide insulation can be suitably used, and a paste containing an inorganic filler, a binder, a dispersant, and a solvent is preferred. In particular, the paste preferably contains boehmite as the inorganic filler, polyvinylidene fluoride as the binder, and N-methyl-2-pyrrolidone as the solvent. As the insulating paste, an insulating paste described in International Publication No. 2021/193286 can be suitably used.

The carbon nanotube dispersion paste, the mixture paste, and the electrode layer of the present invention can be particularly suitably used for a lithium ion secondary battery including a nonaqueous electrolyte.

The lithium ion secondary battery including a nonaqueous electrolyte is a battery including at least a positive electrode, a negative electrode, a separator, and a nonaqueous electrolyte, and is a nonaqueous electrolyte-type lithium ion secondary battery.

### EXAMPLES

Hereinafter, the present invention will be described more specifically with reference to Examples, but it should be noted that the present invention is not limited to these specific embodiments. In the examples, “parts” means parts by mass, and “%” means mass %.

### [Production of Dispersing Resin]

### Production Example 1

N-Methyl-2-pyrrolidone (note 1) in an amount of 75 parts was added to a reaction vessel equipped with a thermometer, a thermostat, a stirrer, a reflux condenser, and a water separator and heated to 120° C. under a stream of nitrogen. After 120° C. was reached, a mixture of monomer species (100 parts in total) shown in Table 1 below and 2 parts of 2,2′-azobis(2-methylbutyronitrile) was added dropwise over 3 hours. After completion of the addition, the resulting mixture was aged at 120° C. for 30 minutes, and a mixture of 1 part of 2,2′-azobis(2-methylbutyronitrile) and 20 parts of N-methyl-2-pyrrolidone (note 1) was added dropwise over 1 hour. The resulting mixture was further aged at 120° C. for 1 hour and then cooled, and N-methyl-2-pyrrolidone (note 1) was added to obtain an acrylic resin (A1) having a solid content of 50%. The polar functional group concentration was 1.3 (mmol/g).
(Note 1) N-methyl-2-pyrrolidone: A regenerated solvent that is obtained by mixing a new product and a regenerated product produced in Application Example 1 at 1/1 and that has a water content of 500 ppm (note 2) and an amine content of 500 ppm (note 2).
(Note 2) The water content and the amine content were measured using a Karl Fischer moisture titrator (manufactured by Kyoto Electronics Manufacturing Co., Ltd., trade name “MKC-610”) and ion chromatography (manufactured by Shimadzu Corporation, trade name “prominence HIC-NS”).

### Production Examples 2 to 5

Acrylic resins (A2) to (A5) having a solid content of 50% were obtained in the same manner as in Production Example 1 except that monomer species shown in Table 1 below were used.

The weight-average molecular weight values of the obtained resins are shown in Table 1 below. In the table, “Resin A1” to “Resin A5” mean “Acrylic resin (A1)” to “Acrylic resin (A5)”, respectively.

TABLE 1

| | | | Production Example | | | | |
|---|---|---|---|---|---|---|---|
| | | | Production | Production | Production | Production | Production |
| | | | Example 1 | Example 2 | Example 3 | Example 4 | Example 5 |
| Dispersing resin name | | | Resin A1 | Resin A2 | Resin A3 | Resin A4 | Resin A5 |
| Monomer | Alkyl | iBA | | | | 40 | |
| species | group | SLMA | | | 40 | | |
| | monomer | SMA | | 40 | | | |
| | | BEMA | 40 | | | | 40 |
| | Other | St | 40 | 40 | 40 | 40 | 40 |
| | monomer | DMAEMA | 20 | 20 | 20 | 20 | |
| | | AN | | | | | 20 |

| | | | | | |
|---|---|---|---|---|---|
| Weight-average molecular weight | 22000 | 22000 | 22000 | 22000 | 22000 |

The abbreviations of the monomer species in Table 1 above are as follows.
iBA: i-Butyl acrylate (which has a hydrocarbon group having 4 carbon atoms)
SLMA: Lauryl methacrylate (which has a hydrocarbon group having 12 carbon atoms).
SMA: Stearyl methacrylate (which has a hydrocarbon group having 18 carbon atoms)
BEMA: Behenyl methacrylate (which has a hydrocarbon group having 22 carbon atoms)
St: Styrene
DMAEMA: N,N-Dimethylaminoethyl methacrylate
AN: Acrylonitrile.

### [Production of Electrode Active Material Composite]

### Production Example 6

One part of a carbon nanotube (CNT-C) shown in Table 2 below, 0.2 parts (solid content 0.1 parts) of the acrylic resin (A1), and 98.8 parts of N-methyl-2-pyrrolidone (note 1) were mixed under stirring, and then mixed with 900 parts of electrode active material particles (spinel-structured lithium nickel manganese oxide particles represented by a compositional formula LiNi_{0.5}Mn_{1.5}O₄, average particle diameter 6 μm, BET specific surface area 0.7 m²/g) to prepare an electrode active material composite (G1) of CNT and electrode active material.

### [Production of Carbon Nanotube Dispersion Paste and Mixture Paste]

### Example 1A

Using a continuous dry bead mill “DRYSTAR SDA1” (manufactured by Ashizawa Finetech Ltd.), with zirconia beads (diameter 3.0 mm) at a filling ratio of 70% and a mill peripheral speed of 5.0 m/s, a carbon nanotube (CNT-C) shown in Table 2 below was pulverized (dry-dispersed) at a feed rate of 0.5 kg/hr.

Subsequently, 5000 parts of N-methyl-2-pyrrolidone (note 1), 80 parts (solid content 40 parts) of polyvinylpyrrolidone (note 3) as a dispersing resin, 1800 parts (solid content 180 parts) of a resin solution (note 4) of KF Polymer W #7300 (manufactured by KUREHA CORPORATION, trade name, polyvinylidene fluoride, weight-average molecular weight 1,000,000), 25 parts of benzylamine as an amine, and 200 parts of the pulverized carbon nanotube were mixed using a Disper under stirring, and the mixture was finally adjusted to a total mass of 10000 parts with N-methyl-2-pyrrolidone (note 1). Subsequently, the mixture was dispersed in a ball mill for 4 hours to produce a carbon nanotube dispersion paste (A-1). The water content of the carbon nanotube dispersion paste (A-1) was 800 ppm (note 2). The above production steps were all carried out in an atmosphere at a dew point of 10° C. or lower.

The dispersion of the carbon nanotube (200 parts) using a Disper was carried out as follows: first, other components were sufficiently mixed, then, a half amount (100 parts) of the CNT was added into the disperser under stirring, and after confirming sufficient mixing, the remainder was further added gradually and dispersed.
(Note 3) Polyvinylpyrrolidone: heterocyclic ring-containing resin, weight-average molecular weight (Mw) 12000, functional group concentration 9 (mmol/g)
(Note 4) The resin solution of polyvinylidene fluoride was obtained in such a manner that polyvinylidene fluoride and N-methyl-2-pyrrolidone (note 1) were mixed and dissolved at a temperature of 80° C. in advance, and then cooled to 30° C. at a cooling rate of about 1° C./min.

TABLE 2

| | Average | | Median | | Specific | Acidic |
|---|---|---|---|---|---|---|
| | outer | Average | diameter | | surface | group |
| CNT | diameter | length | D50 | G/D | area | content |
| name | (nm) | (μm) | (μm) | ratio | (m2/g) | (mmol/g) |
| CNT-A | 8 | 18 | 30 | 0.8 | 300 | 0.02 |
| CNT-B | 10 | 2 | 200 | 0.9 | 280 | 0.05 |
| CNT-C | 9 | 30 | 40 | 0.9 | 255 | 0.04 |
| CNT-D | 11 | 10 | — | 0.7 | 210 | 0.08 |
| CNT-E | 150 | 6 | 15 | 0.14 | 15 | 0.03 |

The above carbon nanotubes are all multi-walled carbon nanotubes.
The median diameter (D50), the G/D ratio, the specific surface area (BET specific surface area), and the acidic group content in Table 2 above were measured by methods described later.

### Examples 2A to 10A and 13A and Comparative Examples 1A to 3A

Carbon nanotube dispersion pastes (A-2) to (A-10) and (A-13) to (A-16) were obtained in the same manner as in Example 1A except that formulations shown in Table 3 below were used.

In Example 8A (carbon nanotube dispersion paste (A-8)), an unpulverized carbon nanotube (CNT-C) was used.

### Examples 11A to 12A and Comparative Example 4A

Water was added to the carbon nanotube dispersion paste (A-3) (water content 800 ppm) obtained in Example 3A to achieve the following water contents (note 2), and the mixtures were sufficiently stirred to obtain the following carbon nanotube dispersion pastes (A-11), (A-12), and (A-17).
Example 12A: Carbon nanotube dispersion paste (A-11), water content 4000 ppm
Example 13A: Carbon nanotube dispersion paste (A-12), water content 8000 ppm
Comparative Example 4A: Carbon nanotube dispersion paste (A-17), water content 12000 ppm

The water content (note 2) of the carbon nanotube dispersion pastes and the results of the evaluation tests described later are shown in Table 3 below.

TABLE 3

| | | Example•Comparative Example | | | | | | | | |
|---|---|---|---|---|---|---|---|---|---|---|
| | | Example | | | | | | | | |
| | | 1A | 2A | 3A | 4A | 5A | 6A | 7A | 8A | 9A |
| CNT dispersion paste name | | A-1 | A-2 | A-3 | A-4 | A-5 | A-6 | A-7 | A-8 | A-9 |
| Dispersing | Polyvinylpyrrolidone | 40 | | | | | | 40 | 40 | |
| resin | Polyvinyl butyral | | 40 | | | | | | | |
| | Acrylic resin (A1) | | | 40 | | | | | | 40 |
| | Acrylic resin (A2) | | | | 40 | | | | | |
| | Acrylic resin (A3) | | | | | 40 | | | | |
| | Acrylic resin (A4) | | | | | | | | | |
| | Acrylic resin (A5) | | | | | | 40 | | | |
| | Polyvinyl alcohol | | | | | | | | | |
| | Polymethyl | | | | | | | | | |
| | methacrylate | | | | | | | | | |
| CNT | CNT-C (pulverized) | 200 | 200 | 200 | 200 | 200 | 200 | 200 | | 200 |
| | CNT-C (unpulverized) | | | | | | | | 200 | |
| Polyvinylidene fluoride | | 180 | 180 | 180 | 180 | 180 | 180 | 180 | 180 | 180 |
| Amine | Benzylamine | 25 | 25 | 25 | 25 | 25 | 25 | | 25 | |
| | Aminomethyl propanol | | | | | | | 25 | | 25 |
| Dehydrating agent (orthomethyl | | | | | | | | | | 1 |
| acetate ester) | | | | | | | | | | |
| Water content (ppm) | | 800 | 800 | 800 | 800 | 800 | 800 | 800 | 800 | 600 |
| Evaluation | Dispersibility | B | B | A | A | A | A | B | C | A |
| | Volume resistivity | B | B | A | A | B | A | B | B | A |
| | (conductivity) | | | | | | | | | |
| | Initial viscosity | B | B | A | B | B | B | B | C | A |
| | Storage stability | S | S | S | S | S | S | S | S | S |

| | | Example•Comparative Example | | | | | | | |
|---|---|---|---|---|---|---|---|---|---|
| | | Example | | | | Comparative Example | | | |
| | | 10A | 11A | 12A | 13A | 1A | 2A | 3A | 4A |
| CNT dispersion paste name | | A-10 | A-11 | A-12 | A-13 | A-14 | A-15 | A-16 | A-17 |
| Dispersing | Polyvinylpyrrolidone | | | | | | | | |
| resin | Polyvinyl butyral | | | | | | | | |
| | Acrylic resin (A1) | 30 | 40 | 40 | 60 | | | | 40 |
| | Acrylic resin (A2) | | | | | | | | |
| | Acrylic resin (A3) | | | | | | | | |
| | Acrylic resin (A4) | | | | | 40 | | | |
| | Acrylic resin (A5) | | | | | | | | |
| | Polyvinyl alcohol | | | | | | 40 | | |
| | Polymethyl | | | | | | | 40 | |
| | methacrylate | | | | | | | | |
| CNT | CNT-C (pulverized) | 200 | 200 | 200 | 200 | 200 | 200 | 200 | 200 |
| | CNT-C (unpulverized) | | | | | | | | |
| Polyvinylidene fluoride | | 180 | 180 | 180 | — | 180 | 180 | 180 | 180 |
| Amine | Benzylamine | 25 | 25 | 25 | 25 | 25 | 25 | 25 | 25 |
| | Aminomethyl propanol | | | | | | | | |
| Dehydrating agent (orthomethyl | | | | | | | | | |
| acetate ester) | | | | | | | | | |
| Water content (ppm) | | 800 | 4000 | 8000 | 800 | 800 | 800 | 800 | 12000 |
| Evaluation | Dispersibility | A | A | A | A | D | D | D | B |
| | Volume resistivity | A | A | A | A | D | D | D | B |
| | (conductivity) | | | | | | | | |
| | Initial viscosity | A | A | A | A | D | D | D | A |
| | Storage stability | S | B | C | S | A | A | D | D |

The amount of resins in Table 3 above is on a solid basis. The composition of dispersing resins in Table 3 above is as follows.
Polyvinyl butyral: average degree of polymerization 600, hydroxyl group content 12 mol %, butyral group content 87 mol %, acetyl group content 1 mol %, polar functional group concentration 1.0 (mmol/g).
Polyvinyl alcohol: average degree of polymerization 600, degree of saponification 80 mol %, polar functional group concentration 16.1 (mmol/g)
Polymethyl methacrylate: weight-average molecular weight 20000, homopolymer of methyl methacrylate, polar functional group concentration 0 (mmol/g)
   The boiling points and molecular weights of amines in Table 3 above are as follows.
Benzylamine: boiling point 185° C., molecular weight 107
Aminomethyl propanol: boiling point 166° C., molecular weight 89.

### Example 1B

Using a Disper, 100 parts of the carbon nanotube dispersion paste (A-1) was mixed with 900 parts of electrode active material particles (spinel-structured lithium nickel manganese oxide particles represented by a compositional formula LiNi_{0.5}Mn_{1.5}O₄, average particle diameter 6 μm, BET specific surface area 0.7 m²/g, water content 100 ppm) to produce a mixture paste (B-1).

The water content of the mixture paste (B-1) was 800 ppm (note 2).
The above production steps were all carried out in an atmosphere at a dew point of 10° C. or lower.

### Examples 2B to 9B and 11B to 12B and Comparative Examples 1B to 4B

Mixture pastes (B-2) to (B-9), (B-11) to (B-12), and (B-14) to (B-17) were obtained in the same manner as in Example 1B except that formulations shown in Table 4 below were used.

### Example 10B

Using a Disper, 100 parts of the carbon nanotube dispersion paste (A-10) was mixed with 1000 parts (electrode active material particles 900 parts) of the electrode active material composite (G1) obtained in Production Example 6 to produce a mixture paste (B-10).

The water content of the mixture paste (B-10) was 800 ppm (note 2).

### Example 13B

Using a Disper, 100 parts of the carbon nanotube dispersion paste (A-13) was mixed with 16 parts (solid content 1.6 parts) of a resin solution (note 4) of KF Polymer W #7300 (manufactured by KUREHA CORPORATION, trade name, polyvinylidene fluoride, weight-average molecular weight 1,000, 000) and 900 parts of electrode active material particles (spinel-structured lithium nickel manganese oxide particles represented by a compositional formula LiNi_{0.5}Mn_{1.5}O₄, average particle diameter 6 μm, BET specific surface area 0.7 m²/g, water content 100 ppm) to produce a mixture paste (B-13).

The water content of the mixture paste (B-13) was 800 ppm (note 2).

The results of the evaluation tests of the mixture pastes described later are shown in Table 3 above.

TABLE 4

| | Example•Comparative Example | | | | | | | | |
|---|---|---|---|---|---|---|---|---|---|
| | Example | | | | | | | | |
| | 1B | 2B | 3B | 4B | 5B | 6B | 7B | 8B | 9B |
| Mixture paste name | B-1 | B-2 | B-3 | B-4 | B-5 | B-6 | B-7 | B-8 | B-9 |
| Carbon nanotube | A-1 | A-2 | A-3 | A-4 | A-5 | A-6 | A-7 | A-8 | A-9 |
| dispersion paste | | | | | | | | | |
| name | | | | | | | | | |

| | Example•Comparative Example | | | | | | | |
|---|---|---|---|---|---|---|---|---|
| | Example | | | | Comparative Example | | | |
| | 10B | 11B | 12B | 13B | 1B | 2B | 3B | 4B |
| Mixture paste name | B-10 | B-11 | B-12 | B-13 | B-14 | B-15 | B-16 | B-17 |
| Carbon nanotube | A-10 | A-11 | A-12 | A-13 | A-14 | A-15 | A-16 | A-17 |
| dispersion paste | | | | | | | | |
| name | | | | | | | | |

### Examples (2-1A) to (2-5A)

Carbon nanotube dispersion pastes (2-A-1) to (2-A-5) were obtained in the same manner as in Example 3A except that CNT species (CNTs were pulverized [dry-dispersed] in the same manner as in Example 1A) shown in Table 5 below were used.

The moisture adsorption properties (X) of the carbon nanotubes and the results of the evaluation tests of the carbon nanotube dispersion pastes described later are shown in Table 5 below.

The moisture adsorption properties (X) were determined by a method described below.

### [Measurement of Moisture Adsorption Properties (X)]

A carbon nanotube (CNT) is weighed to about 5 g, and when the mass of the CNT dried at a temperature of 140° C. for 3 hours is Y1, and the mass of the CNT further left to stand for 24 hours at a temperature of 20° C. and a relative humidity of 65% is Y2, the value of Y obtained by the following formula is the amount of moisture adsorption Y.

Amount of moisture adsorption Y=(Y2−Y1)/Y1×100

Furthermore, when the amount of moisture adsorption is Y (mass %), and a BET specific surface area measured by a method described later is Z (m²/g), the value of X obtained by “X=Y×Z” is the moisture adsorption properties X.

TABLE 5

| | | Example | | | | |
|---|---|---|---|---|---|---|
| | | Example | | | | |
| | | 2-1A | 2-2A | 2-3A | 2-4A | 2-5A |
| CNT dispersion paste name | | 2-A-1 | 2-A-2 | 2-A-3 | 2-A-4 | 2-A-5 |
| CNT name | | CNT-A | CNT-B | CNT-C | CNT-D | CNT-E |
| Moisture | Amount of moisture | 2.56 | 1.43 | 1.02 | 0.86 | 1.67 |
| adsorption | adsorption Y | | | | | |
| properties | BET specific surface | 300 | 280 | 255 | 210 | 15 |
| | area Z | | | | | |
| | Moisture adsorption | 768 | 400 | 260 | 180 | 25 |
| | properties X = (Y × Z) | | | | | |
| Evaluation | Dispersibility | A | A | A | B | C |
| | Volume resistivity | A | A | A | A | B |
| | (conductivity) | | | | | |
| | Initial viscosity | A | A | A | A | A |
| | Storage stability | B | A | S | S | S |

The carbon nanotubes (CNT-A) to (CNT-E) in Table 5 above are as described in Table 2.

### Examples (2-1B) to (2-5B)

Mixture pastes (2-B-1) to (2-B-5) were obtained in the same manner as in Example 1B except that formulations shown in Table 6 below were used.

The results of the evaluation tests of the mixture pastes described later are shown in Table 5 above.

TABLE 6
Table 6

| | Example | | | | |
|---|---|---|---|---|---|
| Example | 2-1B | 2-2B | 2-3B | 2-4B | 2-5B |
| Mixture paste name | 2-B-1 | 2-B-2 | 2-B-3 | 2-B-4 | 2-B-5 |
| CNT dispersion paste name | 2-A-1 | 2-A-2 | 2-A-3 | 2-A-4 | 2-A-5 |

### <Median Diameter (D50)>

The measurement of a median diameter (D50) was carried out using a laser diffraction/scattering particle diameter distribution analyzer “LA-960” (manufactured by HORIBA, Ltd., trade name) according to the following procedure.

### (Preparation of Aqueous Dispersion Medium)

To 100 mL of distilled water, 0.10 g of F10MC (manufactured by NIPPON PAPER INDUSTRIES CO., LTD., trade name, sodium carboxymethyl cellulose (hereinafter also referred to as CMCNa)) was added, and dissolved by stirring at normal temperature for 24 hours or more to prepare an aqueous dispersion medium containing 0.1 mass % of CMCNa.

### (Preparation of Aqueous CMCNa Solution)

To 100 mL of distilled water, 2.0 g of F10MC (manufactured by NIPPON PAPER INDUSTRIES CO., LTD., trade name, sodium carboxymethyl cellulose) was added, and dissolved by stirring at normal temperature for 24 hours or more to prepare an aqueous solution containing 2.0 mass % of CMCNa.

### (Pre-Measurement Treatment)

Into a vial, 6.0 mg of a carbon nanotube was weighed, and 6.0 g of the aqueous dispersion medium was added. An ultrasonic homogenizer (manufactured by Microtech Nichion, Co. Ltd., “SmurtNR-50”) was used for the pre-measurement treatment. After confirming that there was no deterioration of a tip, the tip was adjusted so as to be immersed 10 mm or more below the surface of the sample liquid to be treated. With TIME SET (irradiation time) set to 40 seconds, POW SET to 50%, and START POW to 50% (output 50%), the sample liquid was homogenized by ultrasonic irradiation under an auto-power operation with constant output power, thereby preparing an aqueous carbon nanotube dispersion.

### [Measurement]

<Proportion of dispersed particles of 1 μm or less and median diameter (D50) of carbon nanotube> Using the aqueous carbon nanotube dispersion, the measurement of the proportion of dispersed particles of 1 μm or less and the median diameter (D50) of the carbon nanotube was performed according to the following method.

An optical model of LS 13 320 Universal Liquid Module was set to refractive indexes of 1.520 (carbon nanotube) and 1.333 (water), and after completion of cleaning of the module, about 1.0 mL of the aqueous CMCNa solution was introduced.

After offset measurement, optical axis adjustment, and background measurement were performed at a pump speed of 50%, the prepared aqueous carbon nanotube dispersion was added to a particle size distribution analyzer such that the relative concentration indicating the percentage of light scattered outside the beam by the particles was 8% to 12%, or the PIDS was 40% to 55%. Ultrasonic irradiation (pre-measurement treatment) was performed at 78 W for 2 minutes using a particle size distribution analyzer accessory device, and after circulation was performed for 30 seconds to remove bubbles, particle size distribution measurement was performed. A graph of volume percent versus particle size (particle diameter) was obtained, and the proportion of dispersed particles of 1 μm or less and the median diameter (D50) were determined.

The measurement was carried out as follows: for one carbon nanotube specimen, three measurement samples were collected at different collection points and subjected to particle size distribution measurement, and the proportion of dispersed particles of 1 μm or less and the median diameter (D50) were determined as their average values.

### <G/D Ratio of Carbon Nanotube>

The Raman spectrum of a carbon nanotube was measured by placing the carbon nanotube in a Raman microscope (manufactured by Horiba, Ltd., trade name “XploRA”) and using a laser wavelength of 532 nm. Among the obtained peaks in the spectrum, the maximum peak intensity within the range of 1560 cm⁻¹ or more and 1600 cm⁻¹ or less was defined as G, and the maximum peak intensity within the range of 1310 cm⁻¹ or more and 1350 cm⁻¹ or less was defined as D. The ratio of G/D was determined as the G/D ratio of the carbon nanotube.

### <Specific Surface Area (BET Specific Surface Area)>

For the BET specific surface area of a carbon nanotube, the BET specific surface area (m²/g) was measured in accordance with JIS Z 8830:2013 using a specific surface area meter (BERSORP-MAX (MicrotracBEL Corp.)).

### <Acidic Group Content of Carbon Nanotube (CNT)>

A CNT was accurately weighed to 2 g, immersed in 50 ml of a 0.01 M benzylamine/n-methylpyrrolidone solution, and subjected to dispersion treatment for 1 hour using an ultrasonic irradiator. Thereafter, centrifugation was performed, and the supernatant was filtered through a filter. The benzylamine remaining in the obtained filtrate was quantitatively analyzed by potentiometric titration using 0.1 M hydrochloric acid to determine the acidic group content (mmol/g) per gram of the obtained CNT.

### Evaluation Tests

The carbon nanotube dispersion pastes and the mixture pastes obtained in Examples and Comparative Examples above were subjected to evaluation tests. In the evaluations, D is unacceptable. If there is even one unacceptable evaluation result, the evaluation of the carbon nanotube dispersion paste or the mixture paste is unacceptable.

### <Dispersibility>

The obtained carbon nanotube dispersion pastes were evaluated for dispersibility according to the following criteria using a fineness gauge in accordance with the fineness of grind test of JIS K-5600-2-5.
A: The pigment is dispersed at less than 10 μm. The dispersibility is very good.
B: The pigment is dispersed at 10 μm or more and less than 20 μm. The dispersibility is somewhat good.
C: The pigment is dispersed at 20 μm or more, but no aggregates are visually observable. The dispersibility is somewhat poor.
D: Aggregates are visually observable. The dispersibility is very poor.

### <Volume Resistivity (Conductivity)>

For the obtained carbon nanotube dispersion pastes, the measurement of volume resistivity was further performed. In the measurement of volume resistivity, a 5 mass % polyvinylidene fluoride solution (manufactured by KUREHA CORPORATION, trade name “KF Polymer W #7300”, solvent: N-methyl-2-pyrrolidone) was used as a binder.

The carbon nanotube dispersion paste and the KF Polymer W #7300 solution were weighed out such that the ratio of the mass of the carbon nanotube (B) in the obtained carbon nanotube dispersion paste to the total mass of the solid content of the dispersing resin (A) and the solid content of KF Polymer W #7300 in the carbon nanotube dispersion paste was 5:100, and mixed for 2 minutes using an ultrasonic homogenizer to obtain a measurement sample.

The measurement sample was applied onto a glass plate (2 mm×100 mm×150 mm) by doctor blading, and dried by heating at 80° C. for 60 minutes to form a coating film on the glass plate. After the film thickness of the obtained coating film was measured, the resistance value was measured with a resistivity meter (manufactured by Mitsubishi Chemical Analytech Co., Ltd., trade name “Loresta-GP MCP-T610”) using an ASP probe (manufactured by Mitsubishi Chemical Analytech Co., Ltd., trade name “MCP-TP03P”), and the obtained resistance value was multiplied by a resistivity correction factor (RCF) of 4.532 and the film thickness of the coating film to calculate the volume resistivity. The volume resistivity was evaluated according to the following criteria.
A: The volume resistivity is less than 5 Ω·cm, and the conductivity is good.
B: The volume resistivity is 5 Ω·cm or more and less than 15 Ω·cm, and the conductivity is fair.
D: The volume resistivity is 15 Ω·cm or more, and the conductivity is poor.

### <Initial Viscosity>

Using a cone & plate viscometer (manufactured by HAAKE, trade name “Mars2”, a cone & plate with a diameter of 35 mm and an inclination of 2°), the viscosity of the obtained mixture paste was measured at a shear rate of 2.0 sec⁻¹ and evaluated according to the following criteria.
A: The viscosity is less than 10 Pa·s.
B: The viscosity is 10 Pa·s or more and less than 20 Pa·s.
C: The viscosity is 20 Pa·s or more and less than 50 Pa·s.
D: The viscosity is 50 Pa·s or more.

### <Storage Stability>

The obtained mixture paste was stored at a temperature of 50° C. for two weeks, and the initial viscosity and the viscosity after storage were compared with each other. The viscosities were measured at a shear rate of 2.0 s⁻¹ using a cone & plate viscometer (manufactured by HAAKE, trade name “Mars2”, a cone & plate with a diameter of 35 mm and an inclination of 2°). The viscosity increase ratio was determined by the following formula, and the storage stability was evaluated according to the following criteria.

$$Viscosity increase ratio ( \% ) = post - storage viscority ( mPA \cdot s ) / initial viscosity ( mPa \cdot s ) \times 100 - 100$$

S: The viscosity increase ratio (%) after storage is less than 10%.
A: The viscosity increase ratio (%) after storage is 10% or more and less than 20%.
B: The viscosity increase ratio (%) after storage is 20% or more and less than 50%.
C: The viscosity increase ratio (%) after storage is 50% or more and less than 200%.
D: The viscosity increase ratio (%) after storage is 200% or more (or unmeasurable due to gelation).

### [Production of Battery Electrode Layer]

### Application Example 1C

The mixture paste obtained in Example 3B was applied to both sides of a long aluminum foil (positive electrode current collector) having an average thickness of 15 μm in a strip shape by roller coating such that the coating weight per side was 10 mg/cm² (on a solid basis), and dried (at a drying temperature of 180° C. for 30 minutes), thereby forming a positive electrode layer. The positive electrode active material layer (positive electrode layer) supported on the positive electrode current collector was rolled with a roll press machine to adjust the shape.

The obtained electrode layer had a residual solvent amount of less than 1% and was an electrode layer satisfactory in finish quality, etc.
The vapor generated during the drying by heating in the above step was recovered to obtain a recovered solution (mixed solution).
The mixed solution was then placed in a flask equipped with a condenser, and the flask was heated to 185° C. or higher to distill off the amine (benzylamine). This was continued until the amine content was 1000 ppm (note 2) to produce a regenerated product of N-methyl-2-pyrrolidone. The water content of the N-methyl-2-pyrrolidone regenerated product was 1000 ppm (note 2).

### Application Example 2C

After the mixture paste was applied onto an aluminum foil (positive electrode current collector) in a strip shape in the same manner as in Application Example 1, the insulating paste of Example 5A described in International Publication No. 2021/193286 was applied to both end portions of the mixture paste on the aluminum foil (positive electrode current collector) to provide electrode insulating portions. Subsequently, drying (at a drying temperature of 180° C. for 30 minutes) was performed to thereby form a positive electrode layer and insulating portions. The positive electrode active material layer (positive electrode layer) supported on the positive electrode current collector was rolled with a roll press machine to adjust the shape.

1. A method for producing a carbon nanotube dispersion paste, the method being characterized by comprising a step of mixing and dispersing components including a dispersing resin (A) having a heterocyclic ring and/or an alkyl group having 12 or more carbon atoms, a carbon nanotube (B), a solvent (C) having a water content of less than 10000 ppm, and polyvinylidene fluoride (D) that can be included as needed, wherein the carbon nanotube dispersion paste has a water content of less than 10000 ppm.

2. The method for producing a carbon nanotube dispersion paste according to claim 1, characterized in that the mixing and/or the dispersing is carried out in an atmosphere at a dew point of 10° C. or lower.

3. The method for producing a carbon nanotube dispersion paste according to claim 1, characterized in that the dispersing resin (A) having a heterocyclic ring and/or an alkyl group having 12 or more carbon atoms has at least one type of polar functional group selected from the group consisting of an amide group, an imide group, a hydroxyl group, a carboxyl group, a sulfonic acid group, a phosphoric acid group, an amino group, and a cyano group, and has a polar functional group concentration of 0.1 mmol/g to 8.5 mmol/g.

4. The method for producing a carbon nanotube dispersion paste according to claim 1, characterized in that the solvent (C) includes a regenerated product of N-methyl-2-pyrrolidone, and a water content in N-methyl-2-pyrrolidone is controlled at less than 10000 ppm.

5. The method for producing a carbon nanotube dispersion paste according to claim 1, characterized in that the carbon nanotube dispersion paste contains the polyvinylidene fluoride (D).

6. The method for producing a carbon nanotube dispersion paste according to claim 5, characterized in that a step of mixing the polyvinylidene fluoride (D) includes a step of mixing and dissolving the polyvinylidene fluoride (D) in advance with a solvent having a liquid temperature of 40° C. or higher or includes a step of mixing the polyvinylidene fluoride (D) with a solvent and then performing heating to a temperature of 40° C. or higher.

7. The method for producing a carbon nanotube dispersion paste according to claim 1, characterized in that the carbon nanotube dispersion paste further contains a highly polar low-molecular-weight component (E).

8. The method for producing a carbon nanotube dispersion paste according to claim 1, characterized in that the carbon nanotube dispersion paste further contains a dehydrating agent (F).

9. The method for producing a carbon nanotube dispersion paste according to claim 1, characterized in that the carbon nanotube (B) is dry-dispersed in advance with a media-type pulverizer.

10. The method for producing a carbon nanotube dispersion paste according to claim 1, characterized in that the step of mixing and dispersing includes a step of sequentially performing
Step 1: a step of adding the components into a disperser, components including the carbon nanotube (B) in an amount of 70 mass % or less based on 100 mass % of a total amount of the carbon nanotube (B) contained in the carbon nanotube dispersion paste obtained after the dispersion, and performing dispersion treatment, and
Step 2: a step of adding the carbon nanotube (B) into the disperser until a desired concentration is reached, and performing dispersion treatment.

11. The method for producing a carbon nanotube dispersion paste according to claim 1, characterized in that when an amount of moisture adsorption on the carbon nanotube (B) is Y (mass %), and a BET specific surface area of the carbon nanotube (B) is Z (m²/g), a value of X obtained by a formula below:
$$X = Y \times Z$$
is in a range of X≤500, and
when the amount of moisture adsorption Y is measured under conditions where a mass of the carbon nanotube dried at a temperature of 140° C. for 3 hours is Y1, and a mass of the carbon nanotube further left to stand at a temperature of 20° C. and a relative humidity of 65% for 24 hours is Y2, a value (mass %) of Y obtained by a formula below;
Amount of moisture adsorption Y=(Y2−Y1)/Y1×100
is the amount of moisture adsorption Y.

12. A method for producing a mixture paste for a lithium ion secondary battery, the method comprising a step of mixing the carbon nanotube dispersion paste obtained by the method for producing a carbon nanotube dispersion paste according to claim 1 with an electrode active material (G).

13. A method for producing a mixture paste for a lithium ion secondary battery, the method comprising steps below;
a step of producing a carbon nanotube dispersion paste, the step including a step of mixing and dispersing components including a dispersing resin (A) having a heterocyclic ring and/or an alkyl group having 12 or more carbon atoms, a carbon nanotube (B), a solvent (C) having a water content of less than 10000 ppm, and polyvinylidene fluoride (D) that can be included as needed, wherein the carbon nanotube dispersion paste has a water content of less than 10000 ppm, and
a step of producing a mixture paste for a lithium ion secondary battery, the step including a step of mixing the carbon nanotube dispersion paste with an electrode active material (G), wherein the mixture paste has a water content of less than 10000 ppm, and the electrode active material (G) is an electrode active material composite (G-1) obtained by covering at least a part of a surface of the electrode active material (G) with a carbon nanotube.

14. A method for producing an electrode layer for a lithium ion secondary battery, the method comprising a step of applying a mixture paste obtained by the production method according to claim 12 to a current collector.

15. A method for producing an electrode for a lithium ion secondary battery, the method comprising a step of applying an electrode insulating portion to an end portion or an upper layer of the electrode layer obtained by the production method according to claim 14.

16. A method for producing a lithium ion secondary battery, the method using a positive electrode including the electrode layer obtained by the production method according to claim 14, a negative electrode, a nonaqueous electrolyte, and a separator.
